(19) United States
(12) Patent Application Publication
(10) Pub. No.: US 2024/0120598 A1
(43) Pub. Date: Apr. 11, 2024

(54) LINKING MODULE FOR A POWER STATION ASSEMBLY

(71) Applicant: Champion Power Equipment, Inc., Santa Fe Springs, CA (US)

(72) Inventors: Greg Pauken, Hartland, WI (US); James J. Dehn, Brookfield, WI (US); Zhikun Zhong, New Berlin, WI (US); Artur Starosciak, Greendale, WI (US)

(21) Appl. No.: 18/480,725

(22) Filed: Oct. 4, 2023

Related U.S. Application Data
(60) Provisional application No. 63/378,448, filed on Oct. 5, 2022.

(51) Int. Cl. H01M 50/258; H01M 50/264; H01M 50/298

(52) U.S. Cl. CPC H01M 50/258; H01M 50/264; H01M 50/298

(57) ABSTRACT

A power station assembly includes two power stations and a linking module configured to receive respective power outputs from the two power stations and combine the respective power outputs into an increased power output. Each of the two power stations includes a housing having opposing first and second sidewalls and a plurality of power output receptacles positioned on the first sidewall. The linking module includes a housing having opposing first and second ends and configured to fit between the housings of the two power stations in a stacked configuration, with the first end of the housing of the linking module and the first sidewalls of the housings of the two power stations facing the same direction. The linking module further includes at least one power output receptacle located at the first end of the housing and configured to provide the increased power output.

### CROSS-REFERENCE TO RELATED APPLICATIONS

The present application is a non-provisional of and claims priority to U.S. Provisional Patent Application Ser. No. 63/378,448, filed Oct. 5, 2022, the disclosure of which is incorporated herein by reference in its entirety.

### BACKGROUND OF THE INVENTION

Embodiments of the present invention relate to gasless inverter generators or power stations and, more particularly, to a system for increasing power output or energy capacity available to an electrical load by connecting a power station to at least one additional power source.

Fuel generators powered by fossil fuels, such as, for example, gasoline, liquefied petroleum gas (LPG), or natural gas (NG), are commonly used as a mobile or backup power source. Fuel generators can provide power in locations without access to the utility grid or when natural disasters, extreme weather events, or other conditions result in a power outage. Fuel generators require a constant supply of fuel for combustion, and that fuel might not be readily available, particularly in remote locations and when natural disasters or severe weather interrupts the fuel supply. Further, these types of generators contribute to global warming, require frequent maintenance, and emit hazardous exhaust and noise, which makes them unsuitable for indoor environments.

Inverter power stations include battery systems that can store electrical energy for use in locations without access to the utility grid or when a power outage occurs in the grid. Inverter power station users can charge these battery systems with energy from various sources such as, for example, the utility grid using a converter or rectifier that changes alternating current (“AC”) power into direct current (“DC”) power. Alternatively, such users may elect to charge their battery systems with energy from carbon-free renewable energy sources, the use of which generally reduces dependence on fossil fuels and lowers energy bills. As an example, solar panels can charge battery systems to provide a renewable source of stored energy independent from the utility grid, which is convenient for many mobile and off-grid applications. Battery systems can include batteries connected in series or in parallel to expand capacity in terms of voltage and/or current and can power electrical devices that require AC power using an inverter that transforms DC power into AC power.

Portable inverter power stations often have a small size that allows them to be transportable. The size of these portable power stations can determine the space available for onboard battery systems and associated power electronics used to power electrical loads connected to the power stations. As a result, the energy capacity and available power output of a power station are often limited due to the portable nature of the power station. In addition, portable power stations often have power output receptacles couplable to an electrical load and that have a power rating based on the available power output of the power station. However, some loads may require connection to a power output receptacle with a higher power rating than what a smaller power station provides. Unfortunately, a larger power station that includes a larger energy capacity and a higher rated power output can be hard to transport, requires a larger footprint, and can be more costly.

Therefore, it would be desirable to provide a linking module that can electrically connect to multiple portable gasless inverter generators or power stations powered by expandable battery systems, receive power outputs from the power stations, and combine the power outputs together into an increased power output.

### BRIEF STATEMENT OF THE INVENTION

Embodiments of the present invention relate to a linking module connectable to multiple power station to combine their power outputs and provide an increased power output available to power a load.

In accordance with one aspect of the invention, a power station assembly includes first and second power stations and a linking module configured to receive first and second power outputs from the first and second power stations, respectively, and combine the first and second power outputs into an increased power output. Each of the first and second power stations includes a housing having opposing first and second sidewalls, an onboard battery positioned within the housing, and a plurality of power output receptacles positioned on the first sidewall and powered by the onboard battery system. The linking module includes a housing having opposing first and second ends. The housing is configured to fit together with the housings of the first and second power stations in a stacked configuration, with the housing of the linking module between the housings of the first and second power stations and with the first end and the first sidewalls of the housings of the first and second power stations facing the same direction. The linking module also includes at least one power output receptacle located at the first end of the housing and configured to provide the increased power output.

In accordance with another aspect of the invention, a power station assembly includes first and second power stations and a linking module configured to receive first and second power outputs from the first and second power stations and combine the first and second power outputs into an increased power output. Each of the first and second power stations includes a housing having opposing first and second sidewalls, an onboard battery system positioned within the housing, and a plurality of power output receptacles positioned on the first sidewall and powered by the onboard battery system. The linking module includes a housing having opposing first and second ends, a bottom surface configured to securely stack on top of the housing of one of the first and second power stations at a time such that the first end and the first sidewall of the housing of the first and second power stations on which the bottom surface of the housing of the linking module is stacked are facing the same direction, and a top surface configured to securely receive stacked thereon the housing of one of the first and second power stations at a time such that the first end and the first sidewall of the housing of the first power station stacked on the top surface of the housing of the linking module are facing the same direction. The linking module further includes at least one power output receptacle located at the first end of the housing of the linking module and configured to provide the increased power output.

In accordance with yet another aspect of the invention, a method of stacking a power station assembly includes positioning a first power station on a surface. The first power station includes a housing comprising opposing first and second sidewalls, an onboard battery system positioned within the housing, and a plurality of power output receptacles positioned on the first sidewall and powered by the onboard battery system. The method further comprises stacking a linking module on top of the housing of the first power station. The linking module is configured to receive first and second power outputs from the first power station and a second power station, respectively, and combine the first and second power outputs into an increased power output. The linking module includes a housing having opposing first and second ends, a bottom surface securely stacked on top of the housing of the first power station such that the first end and the first sidewall of the housing of the first power station are facing the same direction, and a top surface configured to securely receive stacked thereon the second power station. The linking module also includes at least one power output receptacle located at the first end of the housing and configured to provide the increased power output. In addition, the method includes stacking the second power station on the top surface of the linking module. The second power station includes a housing having opposing first and second sidewalls and stacked on the top surface of the housing of the linking module such that the first sidewall and the first end of the housing of the linking module are facing the same direction. The second power station additionally includes an onboard battery system positioned within the housing and a plurality of power output receptacles positioned on the first sidewall and powered by the onboard battery system.

These and various other features and advantages of the present invention will be more readily understood from the following detailed description and the accompanying drawings.

### BRIEF DESCRIPTION OF THE DRAWINGS

The drawings illustrate embodiments presently contemplated for carrying out the invention.

In the drawings:

FIG. 1 is an upper-right front perspective view of a power station, according to an embodiment of the invention.

FIG. 2 is a partial lower-left rear perspective view of the power station of FIG. 1 with power receptacle covers exploded from the power station, according to an embodiment of the invention.

FIG. 3 is a front view of a control panel of the power station of FIG. 1, according to an embodiment of the invention.

FIG. 4 is an upper-right front perspective view of an expansion battery for the power station of FIG. 1, according to an embodiment of the invention.

FIG. 5 is a lower-left rear perspective view of the expansion battery of FIG. 4 with power receptacle covers exploded from the expansion battery, according to an embodiment of the invention.

FIG. 6 is a rear view of the power station of FIG. 1 coupled to first and second expansion batteries of the type shown in FIG. 4, according to an embodiment of the invention.

FIG. 7 is an upper-left front perspective view of the power station and expansion batteries of FIG. 6 in a stacked configuration with a pair of stack adaptors positioned on handles of the lower expansion battery to support the upper expansion battery thereon, according to an embodiment of the invention.

FIG. 8 is an exploded view of the stacked configuration of the power station and expansion batteries shown in FIG. 7, according to an embodiment of the invention.

FIG. 9 is an upper-right front perspective view of a linking module to couple the power station of FIG. 1 to another power station, according to an embodiment of the invention.

FIG. 10 is an upper-right rear perspective view of the linking module of FIG. 9 with a hinged door of a housing of the linking module open, according to an embodiment of the invention.

FIG. 11 is a lower-left rear perspective view of the linking module of FIG. 9, according to an embodiment of the invention.

FIG. 12 is an upper-right front perspective view of first and second power stations of the type shown in FIG. 1 coupled to the linking module of FIG. 9 in a stacked configuration, according to an embodiment of the invention.

FIG. 13 is an upper-right rear perspective view of the stacked configuration of the first and second power stations and linking module shown in FIG. 12, according to an embodiment of the invention.

FIG. 14 is an upper-left front exploded perspective view of the stacked configuration of the first and second power stations and linking module shown in FIG. 12, according to an embodiment of the invention.

FIG. 15 is an upper-left front perspective view of a power station assembly including the first and second power stations and the linking module of FIG. 12 and the expansion batteries of FIG. 6 in a stacked configuration, with a pair of stack adaptors positioned on handles of the first expansion battery and the second expansion battery positioned on the first expansion battery via the pair of stack adaptors, according to an embodiment of the invention.

FIG. 16 is a block diagram of a power station assembly, according to an embodiment of the invention.

### DETAILED DESCRIPTION

The operating environment of the invention is described herein with respect to a portable gasless inverter generator or power station. However, those skilled in the art will appreciate that the invention is equally applicable for use with nonportable power stations. While the invention will be described with respect to a battery-operated power station having an inverter that converts DC power to AC power, embodiments of the invention are equally applicable for use with battery-operated power stations having a DC-to-DC power converter.

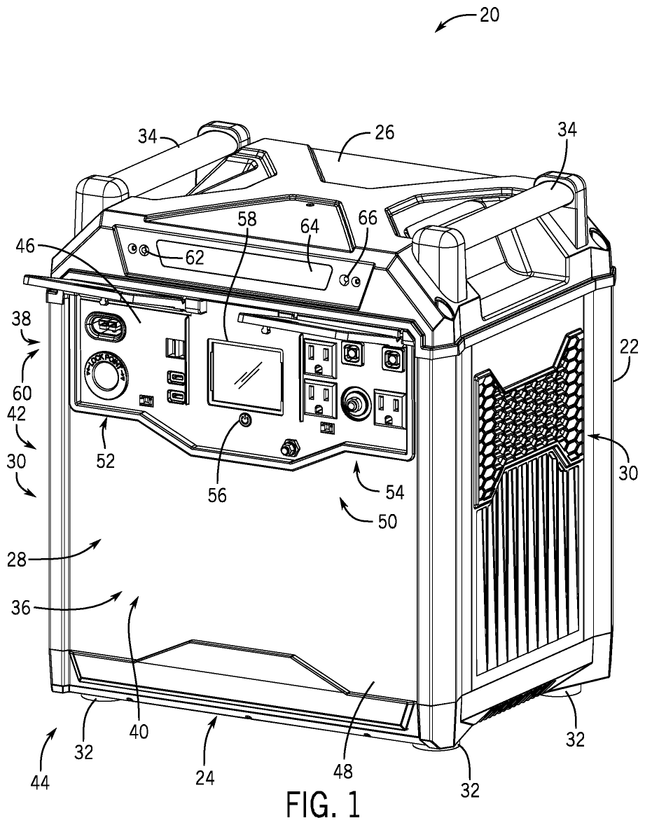

Referring to FIG. 1, an upper-right front perspective view of a portable power station 20 for providing power to electrical devices (not shown in FIG. 1) is shown, according to an embodiment of the invention. The power station 20 includes a housing 22 having a base 24, a top wall or upper surface 26, and a plurality of sidewalls 28 that surround and protect internal components of the power station 20. Cooling vents 30 are positioned in one or more of the sidewalls 28 to provide cooling air to components within the housing 22. The power station 20 may include a plurality of feet 32 extending downward from the base 24 to provide a stable foundation and to raise the housing 22 slightly off of the floor or ground. The power station 20 may include a pair of carrying handles 34 extending upward from the top wall 26 to lift and carry the power station 20. While the carrying handles 34 are shown in FIG. 1 as being oval-shaped, in various embodiments, the carrying handles 34 may have another shape that is comfortable to a user. A single person may be able to lift the power station 20 with one or both of the carrying handles 34, and thus, the power station 20 may act as a convenient mobile power source. Since the carrying handles 34 are also able to support and secure other devices on top of the power station 20, the carrying handles 34 may also be considered supports 34.

The power station 20 typically includes an onboard battery system 36 including one or more batteries (not shown in FIG. 1) and a control system 38 positioned within the housing 22. The onboard battery system 36 may include a rechargeable lithium-ion battery 40 with a chemistry of either nickel manganese cobalt (NMC) or lithium iron phosphate (LFP). The control system 38 may include a converter (not shown in FIG. 1) for converting a voltage from the onboard battery system 36 into another voltage required to operate the electrical devices. The control system 38 may include an inverter 42 to change DC power from the onboard battery system 36 into AC power supplied to the electrical devices. For example, the inverter 42 may provide single or three phase AC power at 50 Hz or 60 Hz. Accordingly, the power station 20 may be referred to as a gasless inverter generator 20.

The power station 20 is shown with a control panel 46 located on a front sidewall 48 of the power station 20. The control panel 46 controls operation of the power station 20 and connects to one or more electrical devices powered by the power station 20. The control panel 46 includes one or more power output receptacles 50 (for example, sockets) that receive electrical connections (for example, plugs) from the electrical devices. The power output receptacles 50 are generally powered by the onboard battery system 36 via the control system 38. The one or more power output receptacles 50 are shown as a plurality of DC power output receptacles 52 and a plurality of AC power output receptacles 54, with the inverter 42 providing AC power to the AC power output receptacles 54.

The control panel 46 includes a power button 56 to turn on and off the power station 20. The power station 20 is turned on/off by the power button 56 when pressed and held for a short period of time. When the power station 20 is on, the power button 56 can also turn the AC power output receptacles 54 on/off when pressed without being held. The control panel 46 may include a display 58, also referred to as a user display panel, to show operating characteristics of the power station 20. The display 58 is typically an automatic display 58 displaying one or more items of information that the control system 38 automatically stores and updates without user input and will be referenced as the automatic display 58 below. However, in some embodiments, the display 58 may also display one or more items of information that control system 38 does not automatically update or may be configured in a manner that requires a manual input from a user for all information updates. In some embodiments, the power button 56 illuminates the automatic display 58 each time it is pressed. The automatic display 58 can display a battery level of the power station 20 to a person using the power station 20. Herein, the battery level of the power station 20 is also referred to as the energy level, charge level, or state of charge of the power station 20. The automatic display 58 may display the battery level in terms of percentages. As such, the battery level is also referenced herein as a percent battery level. The battery level of the onboard battery system 36 may correspond to the battery voltage.

The control system 38 is programmed to determine a THD associated with the AC power from the inverter 42 and to operate the automatic display 58 to indicate the THD to an operator. The automatic display 58 may indicate whether the THD is above a level that could damage sensitive electronic components powered by the inverter 42. High THD is generally caused by a high load on the AC power output receptacles 54 and/or by a low battery level powering the inverter 42. As the battery level drops, the AC power output can be too high for the inverter 42 to simulate a pure sine wave. In various embodiments, the battery level of the onboard battery system 36 corresponds to a voltage output from the battery. Thus, the THD may be determined based on power and voltage output from the power station 20.

The control system 38 may determine the power and voltage output from the power station 20 via measured voltage, current, and/or power values from one or more voltage, current, and/or power sensors (not shown) on the power station 20. Depending on the type of sensor used, the control system 38 may either utilize measured values from the sensors directly or calculate values based on the measured values. Thereafter, the control system 38 may determine the battery level based on the voltage of the onboard battery system 36 and calculate the percent battery level of the onboard battery system 36 at a point in time based on the determined battery level and the battery level capacity of the onboard battery system 36. The THD can therefore be reduced by unplugging one or more AC devices from the power station 20 and/or by charging the onboard battery system 36. If the power output is lower, the inverter 42 will be able to simulate a pure sine wave (for example, a waveform with a low THD) at a lower battery level and for a longer period of time prior to the onboard battery system 36 being recharged.

The control system 38 may be programmed with a THD shield 60 to automatically shut off AC power output from the AC power output receptacles 54 when the THD is above a predetermined level (for example, 5%). The THD shield 60 of the control system 38 may automatically shut off AC power output when the onboard battery system 36 has a battery level below a predetermined battery level, which can indicate that the THD is above a predetermined THD level. In various embodiments, at full AC load (for example, 1,600 Watts (1,600 W)), the THD will rise above 5% at less than 20-25% battery level remaining, and at low loads (for example, 100 W), the THD will not rise above 5% until the onboard battery system 36 is basically dead. Since a charged or partially charged battery might have low THD even at full load, the THD shield 60 could be configured to determine that the battery level of the onboard battery system 36 is lower than a predetermined battery level prior to determining if the THD requires shutting off AC power output. In various embodiments, the predetermined battery level is approximately 30% of a battery level of the onboard battery system 36 when the onboard battery system 36 is at 100% battery level or fully charged and the predetermined THD level is approximately 5%. The DC power output receptacles 52 can remain powered even if the AC power output receptacles 54 are shut off by the THD shield 60.

An overload reset button 62, also referred to as a THD shield button 62, can be pressed to re-energize the DC and AC power output receptacles 52, 54 if they have been shut off due to an electrical fault. The overload reset/THD shield button 62 may also provide a user input control to selectively enable the THD shield 60 while the automatic display 58 indicates whether the THD shield 60 is enabled or disabled. In various embodiments, a user may press the overload reset/THD shield button 62 once to re-energize both AC power output receptacles 54 and DC power output receptacles 52 after an overload fault and five times in three seconds to turn the THD shield 60 on or off. When the THD shield 60 is on and the THD rises above a predetermined level, also referred to as a THD fault level, the control system 38 shuts off AC power output to prevent damage to sensitive electronics. A user may press the overload reset/THD shield button 62 to restore AC power to the AC power output receptacles 54 following a THD shutoff. An LED light 64 that can illuminate a work area in front of the power station 20 is positioned above the control panel 46 adjacent the overload reset button 62 and an LED light button 66 that turns on the LED light 64.

In various embodiments, to restore AC output after the control system 38 shuts off power according to the THD shield 60, a user should charge the power station 20 (if possible), lower the AC running watts by unplugging one or more electrical devices, and press the overload reset button 62 to re-energize the AC power output receptacles 54. In various embodiments, to prevent control system 38 from shutting off power due to the THD shield 60, a user should maintain a high battery level in the onboard battery system 36, charge the power station 20 during use, unplug high current draw AC appliances to lower the AC running watts when the battery falls to near 30% charge capacity, and/or turn off the THD shield 60. In various embodiments, to turn the THD shield 60 off, a user should lower the AC running watts by unplugging one or more devices to limit increasing THD levels as the battery level depletes and press the THD shield button 62 five times within three seconds. When the THD shield 60 is disabled, the control system 38 will not shut off AC power output when the THD rises above the predetermined level. A user should monitor sensitive devices for abnormal operation and disconnect as necessary.

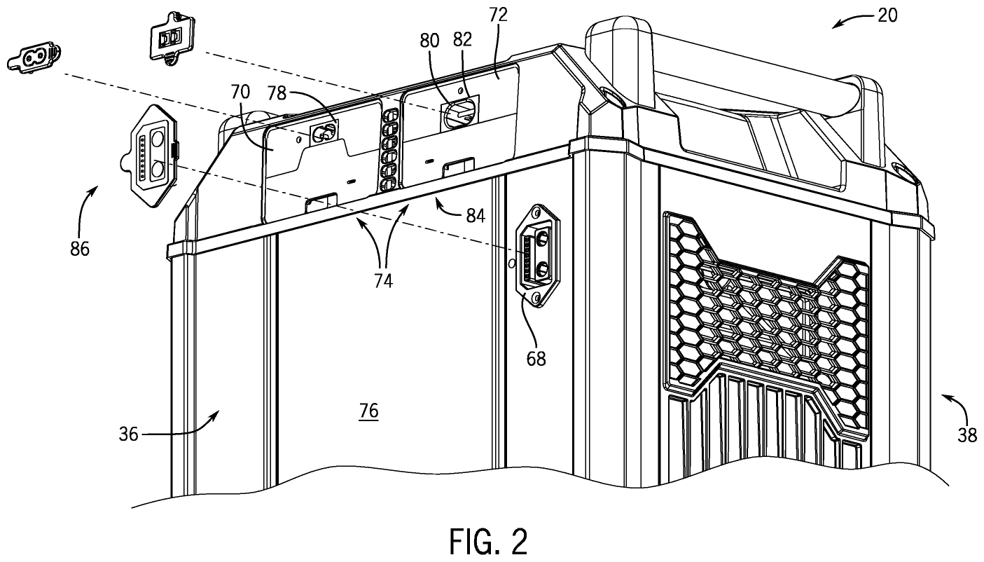

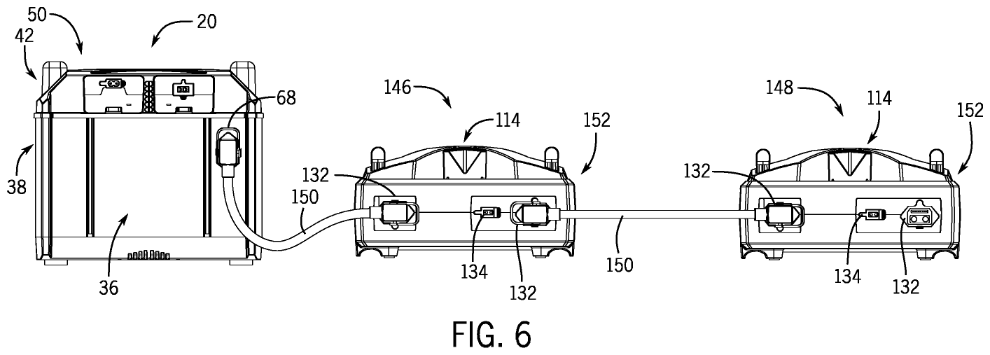

Referring now to FIG. 2, a partial lower-left rear perspective view of the power station 20 is shown with receptacle covers 86 exploded therefrom, according to an embodiment of the invention. The power station 20 includes an external battery port 68 to connect one or more expansion batteries (not shown in FIG. 2), as explained in more detail below with respect to FIG. 6. The power station 20 may couple to a single expansion battery or to a string of expansion batteries (for example, up to ten or more) to increase the battery or energy capacity and runtime of the power station 20. The control system 38 couples the onboard battery system 36 and the external battery port 68 to each of the power output receptacles 50 (FIG. 1).

FIG. 2 shows an AC charging module 70 and a DC charging module 72 that charge the onboard battery system 36 from an AC power source (not shown in FIG. 2) and a DC power source (not shown in FIG. 2), respectively. The AC charging module 70 and the DC charging module 72 are positioned within charging module slots 74 in the rear sidewall 76 of the power station 20. Charging terminals (not shown in FIG. 2) are located within the charging module slots 74 and electrically connect the AC and DC charging modules 70, 72 to the power station 20 when the charging modules 70, 72 are inserted into the charging module slots 74. If a charging module with a different electrical configuration is desired, the AC charging module 70 and the DC charging module 72 can be removed from the charging module slots 74 for replacement.

The AC and DC charging modules 70, 72 have respective AC and DC power inlet receptacles 78, 80 each coupled to the onboard battery system 36 to recharge the power station 20. The AC charging module 70 may include a rectifier (not shown in FIG. 2) to convert AC power from an AC source into DC power supplied to the onboard battery system 36. The AC power inlet receptacle 78 may charge the power station 20 from a traditional wall outlet (not shown in FIG. 2) connected to the utility grid (not shown in FIG. 2). The DC power inlet receptacle 80 may include an APP (Anderson Power Pole) input port 82 that can support DC charging from one or more solar panels (not shown in FIG. 2). The DC charging module 72 may include a maximum power point tracking (MPPT) module 84 to optimize charging of the onboard battery system 36 from the solar panels. The receptacle covers 86 protect the external battery port 68, the AC power inlet receptacle 78, and the DC power inlet receptacle 80 from moisture, dirt, and other debris.

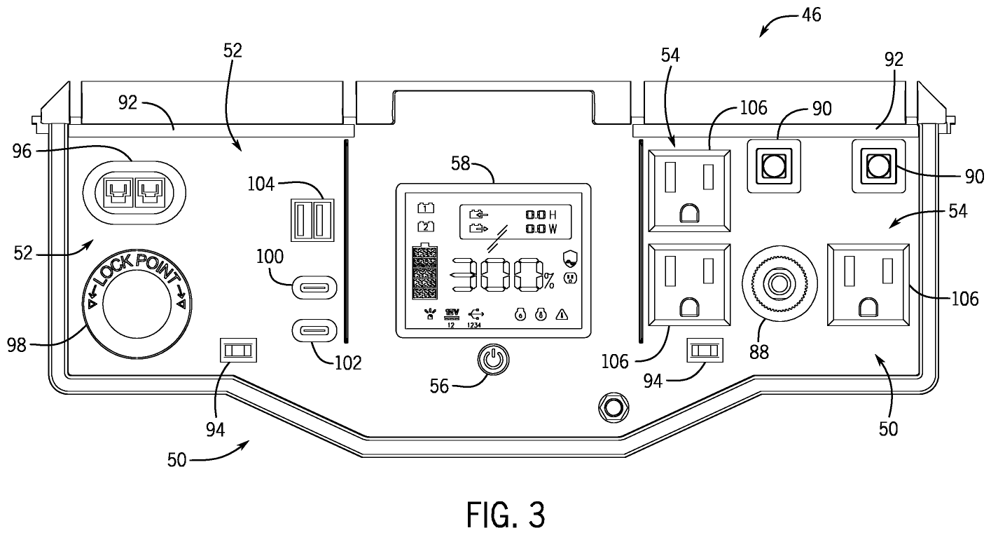

Referring now to FIG. 3, a front view of the control panel 46 of the power station 20 of FIG. 1 is shown, according to an embodiment of the invention. The control panel 46 includes a power button 56 to turn on and off the power station 20 and to illuminate the automatic display 58. The automatic display 58 can indicate the battery level available from the onboard battery system 36 and any connected expansion batteries (not shown in FIG. 3) to a user. The control panel 46 also includes a circuit breaker 88, linking module connection ports or linking kit connection ports 90, and a plurality of selectively openable protective covers 92. The circuit breaker 88 protects the power station 20 against electrical overloads and can be pressed by an operator to reset power to the power output receptacles 50. The linking module connection ports 90 are used to electrically couple AC power outputs from the linking module connection ports 90 of two power stations 20 to a linking kit or module (not shown in FIG. 3) that is able to provide an increased AC power output. The protective covers 92 are hinged to the control panel 46 to selectively cover the power output receptacles 50 and are latched in closed positions by depressible cover locks 94.

The control panel 46 is shown with a plurality of DC power output receptacles 52 that are powered by the onboard battery system 36 and/or any connected expansion batteries (not shown in FIG. 3) and that may output different levels of voltage and current. For example, an APP (Anderson Power Pole) port 96 may supply electrical power for operation of 12-volt (12V) DC, 20-amp (20 A) electrical loads. A regulated automotive port 98 may supply electrical power for operation of 12V DC, 10 A electrical loads. A plurality of Universal Serial Bus (USB) ports may provide power to devices such as, for example, cellphones, laptops, and tablets. A USB Type-C+Power Delivery (PD) port 100 may supply 5V/9V/12V/15V/20V DC, 3 A Fixed or 3.3V-21V DC according to the Programmable Power Supply (PPS) protocol to provide power up to a maximum of 60 watts (60 W) with PD compatible devices. A USB Type-C+Quick Charge (QC) port 102 may supply 3.6V-12V DC, 3 A Fixed (for example, 5V/9V, 3 A Fixed or 12V, 2.5 A Fixed) or 3.6V-12V DC PPS to provide power up to a maximum of 30 W with QC 3.0 compatible devices. USB Type-A ports 104 may supply a maximum of 5V DC, 2.1 A.

The control panel 46 is also shown with a plurality of AC power output receptacles 54 that are powered by the onboard battery system 36 and/or any expansion batteries (not shown in FIG. 3). For example, National Electrical Manufacturers Association (NEMA) 5-15R ports 106 may be used to supply electrical power for operation of 120V AC, 15 A, single phase, 60 Hz electrical loads. However, the AC power output receptacles 54 may provide power from the inverter at any suitable current (for example, any integer or half-integer value from 2.5 A to 30 A) and voltage (for example, any integer value from 110V to 120V AC or any integer value from 220V to 250V AC). In various embodiments, the power button 56 turns on the inverter 42 (FIG. 1) to power the AC power output receptacles 54 while the DC power output receptacles 52 are configured to always receive power.

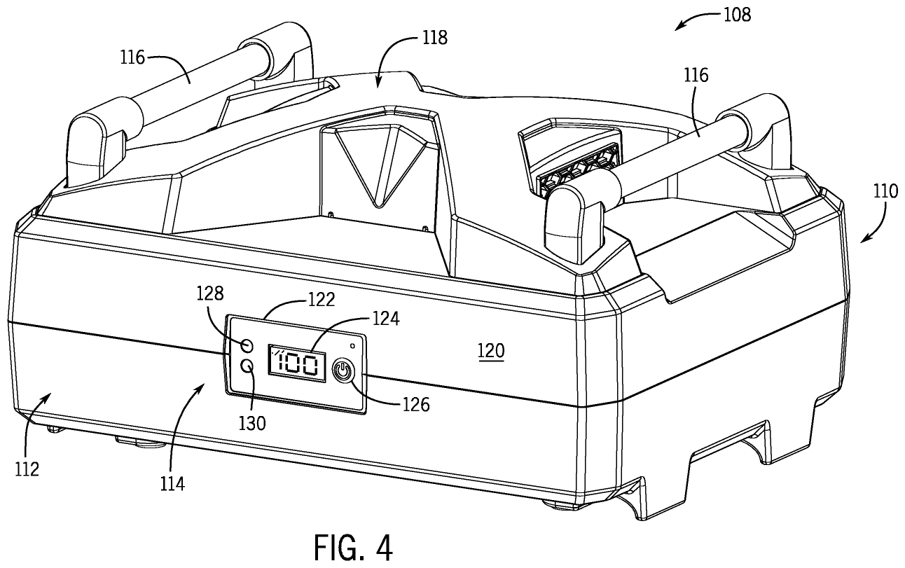

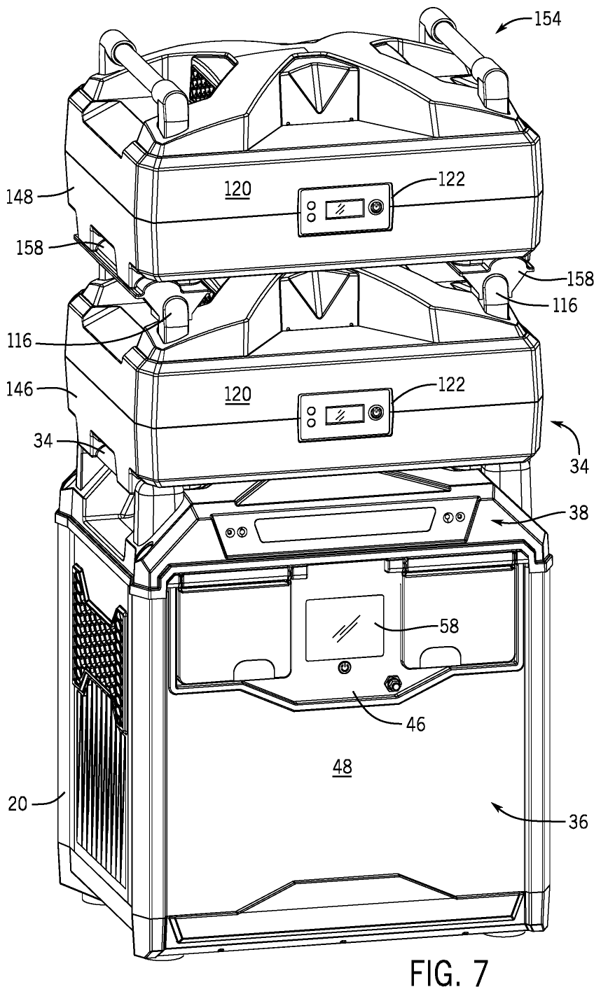

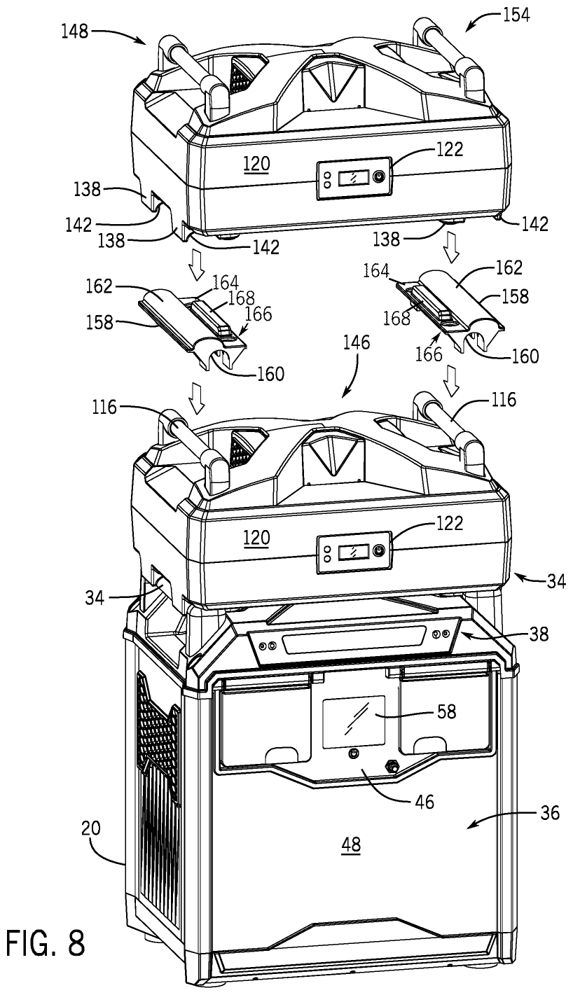

Referring now to FIG. 4, an upper-right front perspective view of an expansion battery 108 for supplying additional power to the power station 20 of FIG. 1 is shown, according to an embodiment of the invention. The expansion battery 108 may include a housing 110 with a battery system 112 including one or more batteries and a control system 114 positioned within the housing. In some embodiments, the battery system 112 is a rechargeable lithium-ion battery with a chemistry of either nickel manganese cobalt (NMC) or lithium iron phosphate (LFP). The control system 114 operates the expansion battery 108 and may include a converter (not shown in FIG. 4) for converting the voltage of battery system 112 into another voltage supplied to the power station 20. A pair of carrying handles 116 extend upward from a top surface 118 of the housing 110 and can be used to lift the expansion battery 108 or to support another expansion battery 108 resting on the handles 116 when in a stacked configuration, as explained in more detail below with respect to FIGS. 7 and 8. Since the carrying handles 116 are also able to support and secure another expansion battery 108 on top of the expansion battery 108, the carrying handles 116 may also be considered supports 116.

A front sidewall 120 of the housing 110 includes a display 122 that shows operating characteristics of the expansion battery 108. The display 122 is generally an automatic display 122 displaying one or more items of information that the control system 114 automatically stores and updates without user input and will be referenced as the automatic display 122 below. However, in some embodiments, the display 122 may also display one or more items of information that the control system 114 does not automatically update or may be configured in a manner that requires a manual input from a user for all information updates. The automatic display 122 includes a fuel or battery gauge 124 that shows a remaining battery level for the expansion battery 108 in terms of percentages. As indicated above with respect to FIG. 1, the remaining battery level may correspond to the battery voltage, and the battery level percentage value is also referenced as a percent battery level. The control system 114 may determine the percent battery level via a measured value from a voltage sensor (not shown) on the expansion battery 108. Depending on the type of voltage sensor, the control system 114 may either utilize measured values from the voltage sensor as voltage values/battery levels or calculate battery levels based on the measured values. Thereafter, the control system 114 may determine the battery level based on the voltage of the battery system 112 and calculate the percent battery level of the battery system 112 at a point in time based on the determined battery level and the battery level capacity of the battery system 112.

The automatic display 122 may also display fault codes when faults occur such as high or low temperature faults, battery or circuitry communication faults, or a battery management system (BMS) fault, as non-limiting examples. A display button 126 turns on/off the automatic display 122 and illuminates the fuel gauge 124. A discharging indicator LED 128 will illuminate red when the automatic display 122 is turned on and the expansion battery 108 is discharging to the power station 20. A charging indicator LED 130 will illuminate green when the automatic display 122 is turned on and the expansion battery 108 is charging.

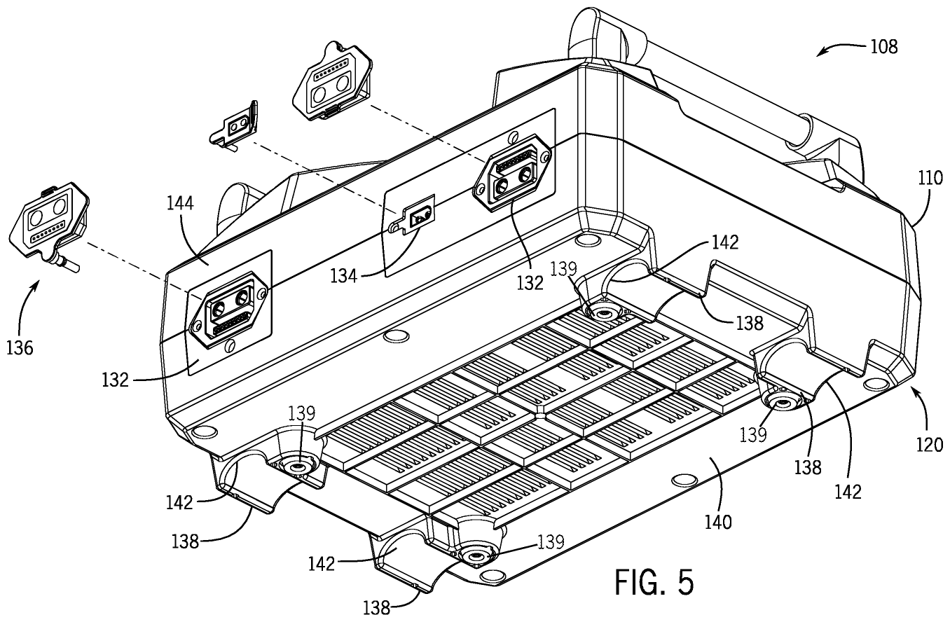

Referring now to FIG. 5, a lower-left rear perspective view of the expansion battery 108 is shown with receptacle covers 136 exploded therefrom, according to an embodiment of the invention. The expansion battery 108 includes a pair of battery connection ports 132. Each of the battery connection ports 132 connect the expansion battery 108 to the power station 20 or to another expansion battery 108. The expansion battery also includes a charging module input port 134 configured to connect to a power cord of a charging module (not shown in FIG. 5) that is configured to charge the expansion battery 108. The receptacle covers 136 protect the battery connection ports 132 and the charging module input port 134 from moisture, dirt, and other debris.

The expansion battery 108 generally includes four feet 138 extending downward from a bottom surface 140 of the housing 110 to secure the expansion battery in a stacked configuration or to raise the housing slightly off of the floor or ground. Each foot 138 includes a base 139 configured to support the expansion battery 108 when placed on a surface (not shown). Further, an arc-shaped cutout 142 is shown extending across each of the feet 138 in a direction from the front sidewall 120 to a rear sidewall 144 of the expansion battery 108. In various embodiments, the expansion battery 108 stacks on the power station 20 with the arc-shaped cutouts 142 in the feet 138 sitting securely on the oval-shaped carrying handles 34 (FIG. 1) of the power station 20. While shown as arc-shaped in FIG. 5, the cutout 142 may have a different shape in various embodiments. In many embodiments, the shape of the cutout 142 will correspond to the shape of the carrying handles 34 such that the carrying handles 34 are able to safely support the expansion battery 108.

Although FIG. 5 shows the expansion battery 108 with a specific configuration of feet 138 and cutouts 142, the expansion battery 108 may have a different number of feet 138 and/or cutouts 142 in different configurations. As a non-limiting example, expansion battery 108 may include two or six feet 138. As another non-limiting example, the expansion battery 108 may include cutouts 142 as separate components from the feet 138. As yet another non-limiting example, the cutouts 142 of the pairs of feet 138 aligned with each other in FIG. 5 and designed to sit securely on the same carrying handle 34 of the power station 20 may be connected across the bottom surface 140 of the housing 110 and considered a single cutout 142. In that case, when those pairs feet 138 are connected by the cutouts 142, the expansion battery 108 may be considered as either having four feet 138 and two cutouts 142 extending between the pairs of the feet 138 or as having two feet 138 each including one cutout 142.

Regardless of the configuration of the feet 138 and cutouts 142 of the expansion battery 108, the feet 138 and cutouts 142 are generally (though not necessarily) designed such that the expansion battery 108 stacks directly on the power station 20 with the front sidewall 48 (FIG. 1) of the power station 20 and the front sidewall 120 of the expansion battery 108 facing the same direction. This enables users to conveniently view and access the control panel 46 (FIG. 1) of the power station 20 and the display 122 (FIG. 4) of the expansion battery 108 from one location. That is, users can view and access the control panel 46 of the power station 20 and the display 122 of the expansion battery 108 without having to move to a different side of the power station 20 and/or expansion battery 108. The same is true regarding the external battery port 68 and AC and DC charging modules 70, 72 in the rear sidewall 76 (FIG. 2) of the power station 20 and the battery connection and charging module input ports 132, 134 in the rear sidewall 144 of the expansion battery 108.

Further, the engagement between the cutouts 142 of the expansion battery 108 and the carrying handles 34 of the power station 20 secures the expansion battery 108 on the power station 20 without preventing the intentional removal of the expansion battery 108 from the power station 20 by a user. That is, when the cutouts 142 of the expansion battery 108 are positioned on the carrying handles 34 of the power station 20, the expansion battery 108 cannot simply slide off of the carrying handles 34. Instead, the carrying handles 34 block the feet 138 of the expansion battery 108 from sliding over the front or rear sidewalls 48, 76 of the power station 20, and the cutouts 142 block the expansion battery 108 from sliding sideways off of the power station 20 to the left or right. Further, the cutouts 142 of the expansion battery 108 and/or the carrying handles 34 may include a non-slip surface.

Therefore, once the cutouts 142 of the expansion battery 108 are on the carrying handles 34 of the power station 20, the expansion battery 108 is protected from falling off of the power station 20 and sustaining damage. A user does not have to trigger any locks or other securing mechanisms or devices in order for this protection to take effect. Rather, a user merely has to place the cutouts 142 of the expansion battery 108 on the carrying handles 34 of the power station 20. Since a user does not have to trigger any locks when placing the expansion battery 108 on the power station 20, a user may similarly remove the expansion battery 108 from the power station 20 without the need to disengage any locks. That is, when a user no longer wants the expansion battery 108 on top of the power station 20 (for example, the expansion battery 108 has a low battery level), the user can simply lift the expansion battery 108 vertically off of the power station 20.

Referring now to FIG. 6, a rear view of the power station 20 connected to a pair of expansion batteries 146, 148 is shown, according to an embodiment of the invention. The expansion batteries 146, 148 are arranged similarly to the expansion battery 108 of FIG. 4, and thus, like elements therein are numbered identically to corresponding elements in the expansion battery 108 of FIG. 4. In FIG. 6, the external battery port 68 of the power station 20 is connected to a first expansion battery 146 and a second expansion battery 148. Each expansion battery 146, 148 may include a pair of battery connection ports 132 that connect to the power station 20 or the other expansion battery 146, 148 using a connection cable 150. Up to ten or more expansion batteries 146, 148 may be chained to the power station 20 to provide additional power. The battery system 112 of each expansion battery 146, 148 increases the battery or energy capacity (watt-hours (Wh) or joules (J)) or runtime of the power station 20. Alternatively, the expansion batteries 146, 148 could be configured to increase the running power or starting power of the power station 20. Each expansion battery 146, 148 also includes a charging module input port 134 for charging the expansion battery 146, 148.

As explained above, the control system 38 of the power station 20 is electrically coupled to the onboard battery system 36 and the external battery port 68 and may include a converter (not shown in FIG. 6) configured to convert a DC voltage to another DC voltage. As a result, the control system 38 of the power station 20 may utilize the converter to convert the DC voltage from the battery systems 112 of the expansion batteries 146, 148 into another DC voltage for distribution from the power station 20. The control system 38 of the power station 20 may additionally include a power inverter 42 to change DC power from each expansion battery 146, 148 to AC power for distribution from the power station 20. In another embodiment, the control system 114 of each expansion battery 146, 148 could provide a DC or AC power to the power station 20 that matches the requirements of any of the power output receptacles 50 of the power station 20. Accordingly, the control system 114 of each expansion battery 146, 148 may include a converter and/or inverter 152 to change DC power from the battery into an AC power supplied to the power station 20. The expansion batteries 146, 148 may also charge the onboard battery system 36 of the power station 20.

Each expansion battery 146, 148 may be paired to the power station 20 so that the control system 38 of the power station 20 can operate the expansion batteries 146, 148. Each expansion battery 146, 148 can be paired by connecting the expansion battery 146, 148 directly to the power station 20 and enabling a pairing feature on the power station 20. According to various embodiments of the invention, a user of the power station 20 may pair the expansion batteries 146, 148 to the power station 20 by performing a series of steps separately for each expansion battery 146, 148. Below is an example in which expansion battery 146 is paired to the power station 20.

In a first step, the user pairing the expansion battery 146 turns on the power station 20 and unplugs all electrical devices therefrom including any additional expansion batteries already connected and/or paired to the power station 20. In a second step, the user connects the expansion battery 146 being paired by connecting its connection cable 150 to the external battery port 68 of the power station 20. In a third step, the user holds down the overload reset button 62 (FIG. 1) of the power station 20 and presses the power button 56 (FIG. 3) of the power station 20 twice. Finally, the LED light 64 (FIG. 1) on the power station 20 will turn on and flash three times in a fourth step. If the LED light 64 does not turn on or flash three times, the user can repeat the second and third steps while ensuring that only the expansion battery 146 is connected to the power station 20. Once the expansion battery 146 is paired with the power station 20, the control system 38 of the power station 20 is able to communicate with and provide instructions to the control system 114 of the expansion battery 146.

In order to pair additional expansion batteries (for example, the expansion battery 148) to the power station 20, the user must disconnect the paired expansion battery 146 and repeat steps one through four above. Once the expansion batteries 146, 148 are paired to the power station 20, the expansion batteries 146, 148 will remain paired to the power station 20 until they are manually unpaired. In various embodiments, unpairing the expansion batteries 146, 148 may be performed by powering down or shutting down the expansion batteries 146, 148, by repeating steps one through four above, or by either method.

Pairing the expansion batteries 146, 148 allows the control system 38 of the power station 20 to discharge the battery system 36, 112 with the highest battery level before discharging the remaining batteries. In various embodiments, the battery level corresponds to a battery voltage and only the battery system or systems 36, 112 with the highest voltage will discharge until the voltage drops to approximately the same voltage level of the battery system or systems 36, 112 with the next highest battery voltage. That is, additional non-discharging battery systems 36, 112 will begin to discharge simultaneously with discharging battery systems 36, 112 when the voltages of the discharging battery systems 36, 112 approximate the voltages of the non-discharging battery systems 36, 112. In various embodiments, the voltages are approximate when the voltage levels or battery levels are within a specific percentage of each other such as 1%, 2%, 3%, 4%, or 5%, as non-limiting examples. However, in various embodiments, the voltages may be approximate when the voltage levels or battery levels are within a specific voltage level of the each other such as 1V or 2V, as non-limiting examples.

For example, the battery system 36, 112 with the highest battery level among the expansion batteries 146, 148 and the power station 20 could discharge first until the battery level is similar to the battery system 36, 112 that had the second highest battery level. The two battery systems 36, 112 will then discharge simultaneously to the level of the third highest battery level. Once all remaining battery levels are similar, each battery system 36, 112 will discharge simultaneously or at the same rate. Thus, the battery systems 112 of the expansion batteries 146, 148 may only begin discharging if their battery levels are equal to or greater than the battery level of the battery system 36 of the power station 20.

Referring now to FIGS. 7 and 8, a power station assembly 154 is shown, according to an embodiment of the invention. FIG. 7 shows an upper-left front perspective view of the power station assembly 154 including the power station 20 and the expansion batteries 146, 148 of FIG. 6 in a stacked configuration. FIG. 8 shows an exploded view of the power station assembly 154 of FIG. 7. While FIGS. 7 and 8 show the power station assembly 154 with two expansion batteries 146, 148, any suitable number of expansion batteries could be stacked on the power station 20 (for example, up to ten or more). The first expansion battery 146 is stacked directly on the carrying handles 34 of the power station 20. The second expansion battery 148 is stacked on the carrying handles 116 of the first expansion battery 146 via a pair of stacking adaptors 158. The stacking adaptors 158 sit or snap onto the carrying handles 116 of the first expansion battery 146 to secure the second expansion battery 148 to the first expansion battery 146.

As shown, when the first and second expansion batteries 146, 148 are stacked on the power station 20, the front sidewall 48 of the power station 20 and the front sidewalls 120 of the expansion batteries 146, 148 are facing the same direction. As such, a user of the power station assembly 154 is able to view and access the control panel 46 of the power station 20 and the displays 122 of the first and second expansion batteries 146, 148 in one location. That is, a user can view and access the control panel 46 of the power station 20 and the displays 122 of the expansion batteries 146, 148 without having to move to a different side of the power station 20 and/or expansion batteries 146, 148. The same is true regarding the external battery port 68 and AC and DC charging modules 70, 72 in the rear sidewall 76 (FIG. 2) of the power station 20 and the battery connection and charging module input ports 132, 134 in the rear sidewalls 144 (FIG. 5) of the expansion batteries 146, 148. This provides the users with a convenient presentation of information and access to functionality when using the power station assembly 154.

Additionally, the engagement between the cutouts 142 of the first expansion battery 146 and the carrying handles 34 of the power station 20 secures the first expansion battery 146 on the power station 20 without preventing the intentional removal of the first expansion battery 146 from the power station 20 by a user. That is, when the cutouts 142 of the first expansion battery 146 are positioned on the carrying handles 34 of the power station 20, the first expansion battery 146 cannot simply slide off of the carrying handles 34. Instead, the carrying handles 34 block the feet 138 of the expansion battery 108 from sliding over the front or rear sidewalls 48, 76 of the power station 20 and the cutouts 142 block the first expansion battery 146 from sliding sideways off of the power station 20 to the left or right.

Therefore, once the cutouts 142 of the first expansion battery 146 are on the carrying handles 34 are on the power station 20, the first expansion battery 146 is protected from falling off of the power station 20 and sustaining damage. A user does not have to trigger any locks or other securing mechanisms or devices in order for this protection to take effect. Rather, a user merely has to place the cutouts 142 of the first expansion battery 146 on the carrying handles 34 of the power station 20. Since a user does not have to trigger any locks when placing the first expansion battery 146 on the power station 20, the user may similarly remove the first expansion battery 146 from the power station 20 without the need to disengage any locks. That is, when a user no longer wants the first expansion battery 146 on top of the power station 20 (for example, the first expansion battery 146 has a low battery level), the user can simply lift the first expansion battery 146 vertically off of the power station 20. A user may remove the second expansion battery 148 with the first expansion battery 146 or may remove the second expansion battery 148 before removing the first expansion battery 146, as desired.

The stacking adaptors 158 on the carrying handles 116 of the first expansion battery 146 provide support for the second expansion battery 148 in a similar manner as the carrying handles 34 on the power station 20 with respect to the first expansion battery 146. Each stacking adaptor 158 has a lower surface with one or more semicircular cutouts 160 along a length of the stacking adaptor 158. In the embodiment shown in FIGS. 7 and 8, the stacking adaptors 158 each include four semicircular cutouts 160. However, in various embodiments, the stacking adaptors 158 have a different number of cutouts 160. As a non-limiting example, each stacking adaptor 158 may include one cutout 160 extending the entire length of the stacking adaptor 158. As another non-limiting embodiment, each stacking adaptor 158 may include two cutouts 160. Regardless of the number and configuration of the cutouts 160, each cutout 160 of one stacking adaptor 158 sits or snaps on one rod-shaped carrying handle 116 of the first expansion battery 146.

Each stacking adaptor 158 also has an oval-shaped upper surface 162 extending the length of the stacking adaptor 158. The upper surfaces 162 are configured to receive the cutouts 142 in the feet 138 of the second expansion battery 148 much like the carrying handles 34 of the power stations 20. Accordingly, the stacking adaptors 158 secure the feet 138 of the second expansion battery 148 to the carrying handles 116 of the first expansion battery 146, even if the feet 138 have a geometry that fits securely on the oval-shaped carrying handles 34 of the power station 20. Although the handles 116 and feet 138 of the expansion batteries 146, 148 and the cutout 160 of the stacking adaptor 158 are described with particular shapes or configurations, in various embodiments, other shapes or configurations may be used. However, the handles 116 are typically designed for the comfort of a user.

The stacking adaptors 158 also include a flat upper surface 164 with two openings 166 for receiving the base 139 of two feet 138 of the second expansion battery 148. The flat upper surface also includes a raised section 168 between the two openings 166. When the feet 138 of the second expansion battery 148 are positioned with the cutouts 142 on the oval-shaped upper surfaces 162, the bases 141 of the feet 138 are positioned in the openings 166 in the flat upper surfaces 164, and the raised sections 168 on the flat upper surfaces 164 are positioned between the feet 138. This positioning of the feet 138 of the second expansion battery 148 on the upper surfaces 162, 164 of the stacking adaptor 158 aids in securing the second expansion battery 148 on the first expansion battery 146.

Regardless of the configuration of the cutouts 160 and upper surface 162 of the stacking adaptor, the cutouts 160 and upper surface 162 are generally (though not necessarily) designed such that the second expansion battery 148 (or another expansion battery 108) stacks on the first expansion battery 146 (or another expansion battery 108) with the front sidewalls 120 of the expansion batteries 146, 148 facing the same direction. This enables users to conveniently view and access the displays 122 of the expansion batteries 146, 148 from one location, as explained above. This also applies to the battery connection and charging module input ports 132, 134 in the rear sidewalls 144 (FIG. 5) of the expansion batteries 146, 148.

Further, the engagement between the cutouts 142 of the second expansion battery 148 and the upper surfaces 162 of the stacking adaptors 158 secures the second expansion battery 148 on the first expansion battery without preventing the intentional removal of the expansion battery 148 from the first expansion battery 146 by a user. That is, when the cutouts 160 of the stacking adaptors 158 are positioned on the carrying handles 116 of the first expansion battery 146, the stacking adaptors 158 cannot simply slide off of the carrying handles 116 of the first expansion battery 146. Instead, the carrying handles 116 block the cutouts 160 of the stacking adaptors 158 from sliding over the front or rear sidewalls 120, 144 of the first expansion battery 146, and the cutouts 160 prevent the stacking adaptors 158 from sliding sideways off of the carrying handles 116 of the first expansion battery 146 to the left or right.

Further, when the cutouts 142 of the second expansion battery 148 are positioned on the upper surfaces 162 of the stacking adaptors 158, the cutouts 142 block the second expansion battery 148 from sliding sideways off of the of the upper surfaces 162 of the stacking adaptors 158. Similarly, the engagement between the bases 139 of the feet 138 of the second expansion battery 148 and the openings 166 in the upper surfaces 164 and between the feet 138 of the second expansion battery 148 and the raised sections 168 of the upper surfaces 164 prevent the second expansion battery 148 from sliding off over the front or rear sidewalls 120, 144 of the first expansion battery 146. Further, the upper surfaces 162, 164 may include a non-slip surface to prevent the second expansion battery 148 from sliding off over the front or rear sidewalls 120, 144 of the first expansion battery 146.

Therefore, once the cutouts 160 of the stacking adaptors 158 are on the carrying handles 116 of the first expansion battery 146 and the cutouts 142 of the feet 138 of the second expansion battery 148 are on the upper surfaces 162 of the stacking adaptors 158, the expansion battery 148 is protected from falling off of the power station assembly 154 and sustaining damage. A user does not have to trigger any locks or other securing mechanisms or devices in order for this protection to take effect. Rather, a user merely has to place the cutouts 160 of the stacking adaptors 158 on the carrying handles 116 of the first expansion battery 116 and the cutouts 142 of the second expansion battery 148 on the upper surfaces 162 of the stacking adaptors 158. Since a user does not have to trigger any locks when placing stacking adaptors 158 and the second expansion battery 148 the stacking configuration, a user may similarly remove the second expansion battery 148 and the stacking adaptors 158 without the need to disengage any locks. That is, when a user no longer wants the second expansion battery 148 on top of the first expansion battery 146 (for example, the second expansion battery 148 has a low battery level), the user can simply lift the second expansion battery 148 vertically off of the stacking adaptors 158. Similarly, a user can remove the stacking adaptors 158 by pulling them off of the carrying handles 116 of the first expansion battery 146.

In addition to the stacking capabilities enabled by the configuration of power assembly 154, the control system 38 of the power station 20 may be configured to determine a number of expansion batteries 146, 148 electrically coupled to the power station 20, determine a battery level of each expansion battery 146, 148, and calculate a battery level available to the power station 20 by adding together the battery level of each expansion battery 146, 148. The control system 38 of the power station 20 may be programmed to sense each expansion battery 146, 148 coupled to the power station 20 by determining which expansion batteries 146, 148 are paired with the power station 20 and/or communicating with the control system 114 of each paired expansion battery 146, 148. The control system 38 may be programmed to determine the battery level of the battery system 112 of each expansion battery 146, 148 by reading the battery gauge 124 on each expansion battery 146, 148. The control system 38 may be programmed to add together the battery level of each expansion battery 146, 148 by adding together the percent battery level of each expansion battery 146, 148. In an alternative embodiment, the control system 38 may be configured to calculate a battery level available to the power station 20 by adding together the battery level of the onboard battery system 36 and the battery system 112 of each expansion battery 146, 148 electrically coupled to the power station 20. The automatic display 58 of the power station 20 operated by the control system 38 may display the available battery levels of the onboard battery system 36 and the battery systems 112 of the expansion batteries 146, 148.

The battery levels of the battery system 112 of each expansion battery 146, 148 electrically coupled to the power station 20 may comprise percent battery levels, and the battery level available to the power station 20 from battery system 36 and/or battery systems 112 may comprise a percent battery level relative to a capacity of the battery system 112 of a single expansion battery 146, 148 electrically coupled to the power station 20. The automatic display 58 may display the available battery level to the power station 20 as a percentage of a single expansion battery 146, 148 electrically coupled to the power station 20. That is, the automatic display 58 of the power station 20 may display that the total percent battery level is higher than 100% when the battery levels of the battery systems 112 of each expansion battery 146, 148 electrically coupled to the power station 20 have a total value greater than the capacity of the battery system 112 of a single expansion battery 146, 148. The automatic display 58 of the power station 20 may also display that the total percent battery level is higher than 100% when the battery levels of the battery system 36 of the power station 20 and each expansion battery 146, 148 electrically coupled to the power station 20 have a total value greater than the capacity of the battery system 112 of a single expansion battery 146, 148.

The control system 38 may calculate the power output and hours to empty for a particular load and operate the automatic display 58 to display the power output and/or hours to empty. The battery level available to the power station 20 is typically independent of an electrical load on the power station 20, but may be dependent on an electrical load on the power station 20 in some embodiments. Thus, the control system 38 may calculate the combined energy level of the expansion batteries 146, 148 coupled to the power station 20 independent of or dependent on an electrical load on the power output receptacles 50 (FIG. 1).

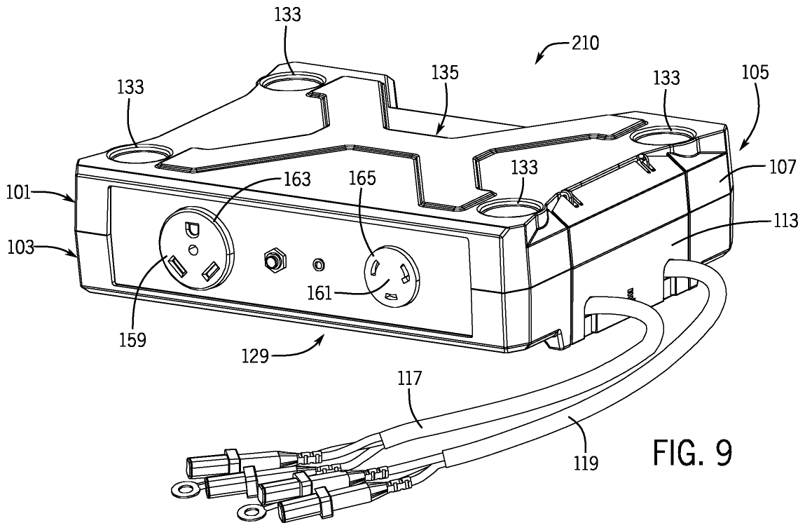

Referring now to FIGS. 9-11, upper-right front perspective, upper-right rear perspective, and lower-left rear perspective views, respectively, of a linking module 210 configured to combine power received from two connectable inverter power stations 20 (FIG. 1) are shown, according to an embodiment of the invention. The linking module 210 (also referred to as a linking kit 210, link 210, or paralink 210) may electrically connect to at least one AC power output receptacle (for example, the linking module connection ports 90 (FIG. 3)) of a first power station 20 (not shown in FIGS. 9-11) and a second power station 20 (not shown in FIGS. 9-11) to receive respective first and second AC power outputs therefrom and to combine the first and second AC power outputs into a third AC power output. The linking module 210 may provide the third AC power output to an electrical device (not shown in FIGS. 9-11) coupled to one or more power output receptacles (not shown in FIGS. 9-11) of the linking module 210.

In various embodiments of the invention, the linking module 210 includes a housing 101 that has a generally rectangular shape with a front end 103, a back end 105, a right side 107, and a left side 109. A handle 111 is positioned at the back end 105 of the housing 101, and a hinged door 113 is positioned at the right side 107 of the housing 101. However, in various embodiments, the hinged door 113 is positioned at the left side 109 of the housing 101.

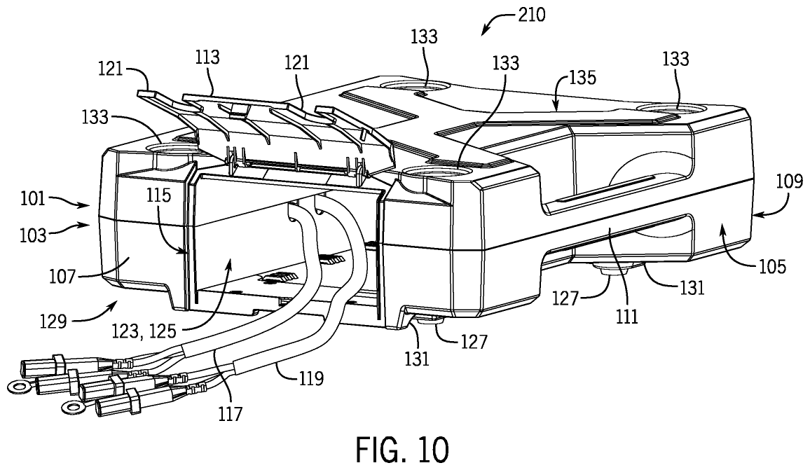

The linking module 210 is shown with the hinged door 113 in an open position in FIG. 10 to expose an interior compartment 115 in the housing 101 and with first and second pairs of connection cables 117, 119 extending out of the interior compartment 115. The pairs of connection cables 117, 119 are couplable to the linking module connection ports 90 of the power stations 20 to receive power therefrom. The hinged door 113 may close over the pairs of connection cables 117, 119 with the cables extending through slots 121 in the hinged door 113 when the hinged door 113 is closed, as shown in FIG. 9. The hinged door 113 can be opened to easily place the pairs of connection cables 117, 119 inside the housing 101 for storage and to access internal components within the housing 101. The linking module 210 may also include a control system 123 positioned therein to operate the linking module 210 and a converter 125 for converting power received from the power stations 20 into a desired form with voltages and currents that are optimally suited for user loads.

In various embodiments, the linking module 210 includes one or more power output receptacles 159, 161 configured to provide the third AC power output, and the third AC current rating may be an AC current rating of the power output receptacles 159, 161. For example, the linking module 210 may include at least one AC power output receptacle 159, 161 configured to provide a third AC power output at the AC voltage and a third AC current that is a combination of the first and second AC currents of a first inverter power station 20 (not shown in FIGS. 9-11) and a second inverter power station 20 (not shown in FIGS. 9-11) and that does not exceed a third AC current rating of the linking module 210, the third AC current rating being higher than each of the first and second AC current ratings. The at least one AC power output receptacle 159, 161 of the linking module 210 may have a voltage rating equal to a voltage rating of the power output receptacles (not shown in FIGS. 9-11) of the first and second inverter power stations 20, 20. In various embodiments, the one or more power output receptacles 159, 161 of the linking module 210 includes a 120V AC, 30 A RV receptacle (or a NEMA TT-30R receptacle) 163 and a 120V AC, 30 A locking receptacle (or a NEMA L5-30R receptacle) 165.

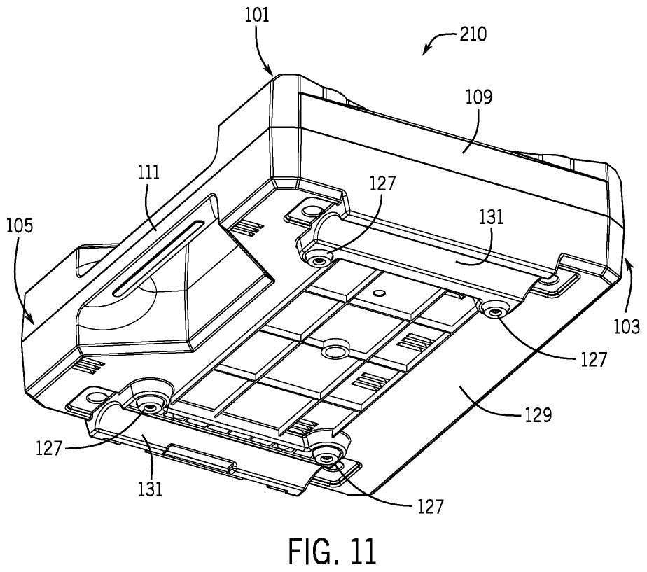

As shown mostly clearly in FIG. 11, the linking module 210 may include a plurality of feet 127 extending downward from a bottom surface 129 of the housing 101 to secure the linking module 210 in a stacked configuration directly on top of the carrying handles 34 of one power station 20 of FIG. 1, much like the expansion battery 108 of FIG. 4, or to raise the housing 101 slightly off of the floor or ground. Two arc-shaped cutouts 131 are shown extending across the bottom surface 129 of the housing 101 in a direction from the front end 103 to the back end 105 of the linking module 210 and extending through the feet 127. In the configuration shown, the linking module 210 may be considered as either having four feet 127 and two cutouts 131 extending between and through pairs of the feet 127 aligned with each other or as having two feet 127 each including one cutout 131.

Although FIG. 11 shows the linking module 210 with a specific configuration of feet 127 and cutouts 131, the linking module 210 may have a different number of feet 127 and/or cutouts 131 in different configurations. As a non-limiting example, the linking module 210 may include four separate feet 127 each having its own cutout 131 in a similar manner to the feet 138 with cutouts 142 on the expansion battery 108 of FIG. 4. As another non-limiting example, the linking module 210 may include a different number of feet 127 such as, for example, six or eight feet 127. In addition, the cutouts 131 may have a different shape to match a different shape on the carrying handles 34 of the power station 20.

While four feet 127 are shown, the linking module 210 may have a different number of feet 127 such as two or six feet 127, as non-limiting examples. In various embodiments, the linking module 210 stacks on a power station 20 with the arc-shaped cutouts 131 sitting securely on the oval-shaped carrying handles 34 (FIG. 1) of the power station 20. While shown as arc-shaped in FIG. 4, the cutouts 131 may have a different shape in various embodiments. In many embodiments, the shape of the cutouts 131 will correspond to the shape of the carrying handles 34 such that the carrying handles 34 are able to safely support the linking module 210.

Regardless of the configuration of the feet 127 and cutouts 131 of the linking module 210, the feet 127 and cutouts 131 are generally (though not necessarily) designed such that the linking module 210 stacks directly on the power station 20 with the front sidewall 48 (FIG. 1) of the power station 20 and the front end 103 of the linking module 210 facing the same direction. This enables users to conveniently view and access the control panels 46 (FIG. 1), receptacles 50 (FIG. 1), and ports 90 (FIG. 1) of the first and second power stations 20 and the receptacles 159, 163 of the linking module 210. That is, users can view and access the control panels 46, receptacles 50, and ports 90 on the first and second power stations 20 and the receptacles 159, 163 on the linking module 210 without having to move to a different side of the power stations 20 and/or linking module 210.

Further, the engagement between the cutouts 131 of the linking module 210 and the carrying handles 34 of the power station 20 secures the linking module 210 on the power station 20 without preventing the intentional removal of the linking module 210 from the power station 20 by a user. That is, when the cutouts 131 of the linking module 210 are positioned on the carrying handles 34 of the power station 20, the linking module 210 cannot simply slide off of the carrying handles 34. Instead, the carrying handles 34 block the feet 127 of the linking module 210 from sliding over the front or rear sidewalls 48, 76 of the power station 20, and the cutouts 131 block the linking module 210 from sliding sideways off of the power station 20 to the left or right. Further, the cutouts 131 of the linking module 210 and/or the carrying handles 34 may include a non-slip surface.

Therefore, once the cutouts 131 of the linking module 210 are on the carrying handles 34 of the power station 20, the linking module 210 is protected from falling off of the power station 20 and sustaining damage. A user does not have to trigger any locks or other securing mechanisms or devices in order for this protection to take effect. Rather, a user merely has to place the cutouts 131 of the linking module 210 on the carrying handles 34 of the power station 20. Since a user does not have to trigger any locks when placing the linking module 210 on the power station 20, a user may similarly remove the linking module 210 from the power station 20 without the need to disengage any locks. That is, when a user no longer wants the linking module 210 on top of the power station 20 (for example, the user no longer requires the increased power output), the user can simply lift the linking module 210 vertically off of the power station 20.

The linking module 210 may also include power station mounts 133 on an upper surface 135 thereof to receive and secure the plurality of feet 32 (FIG. 1) from a power station 20 stacked thereon. The power station mounts 133 are shown as circular mounting indentations that match a corresponding geometry of the feet 32. Although the power station mounts 133 of the linking module 210 and the feet 32 of the power station 20 are described with particular shapes or configurations, in various embodiments, other shapes or configurations may be used. As a non-limiting example, the power station mounts 133 of the linking module 210 may be square-shaped to match square-shaped feet 32 of the power station 20. As another non-limiting example, the linking module 210 may include a different number of power station mounts 133 to accommodate a lower or higher number of feet 32 of the power station 20 such as, for example, two or six power station mounts 133. Accordingly, the linking module 210 may stack between first and second power stations 20, with the linking module 210 secured on the oval-shaped carrying handles 34 of the first power station 20 and the second power station 20 secured on the power station mounts 133 of the linking module 210.

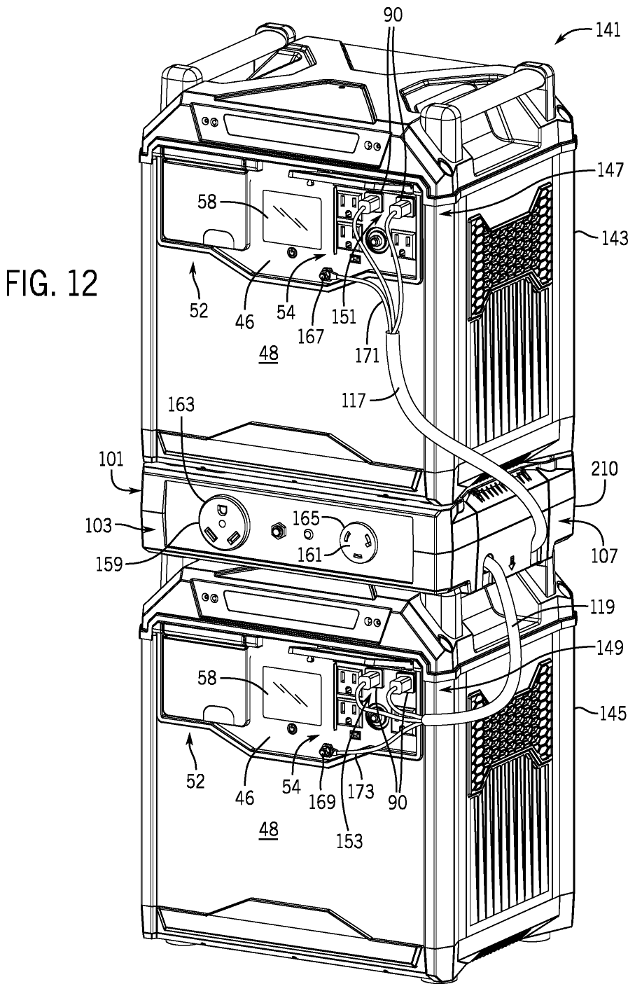

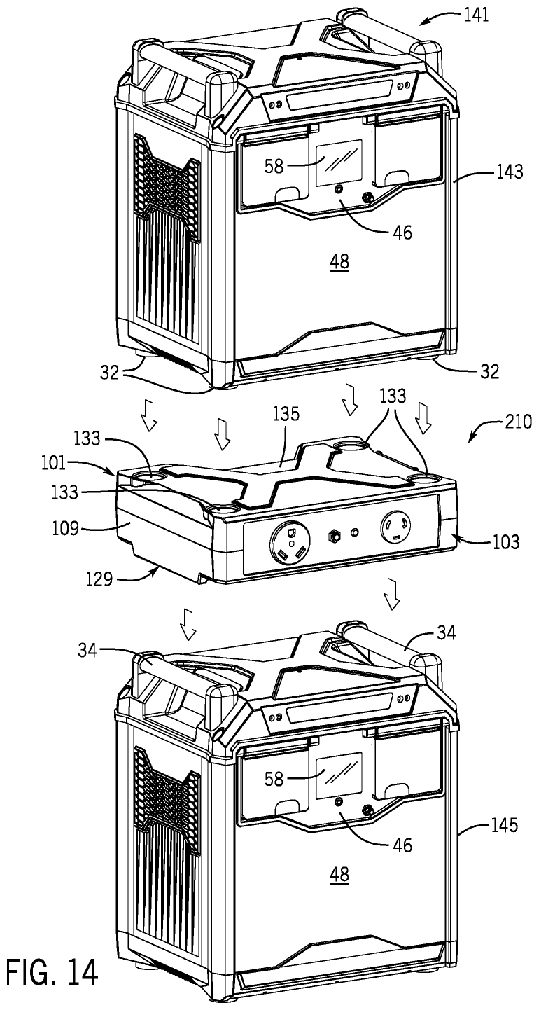

Referring now to FIGS. 12-14, upper-right front perspective, upper-right rear perspective, and upper-left front exploded perspective views, respectively, of a power station assembly 141 are shown, according to an embodiment of the invention. The power station assembly 141 may include a first inverter power station 143, a second inverter power station 145, and the linking module 210 of FIG. 9 in a stacked configuration. The first and second inverter power stations 141, 143 are arranged similarly to the power station 20 of FIG. 1, and hence, like elements therein are numbered identically to corresponding elements in the power station 20 of FIG. 1. The first inverter power station 143 may be configured to provide a first AC power output at an AC voltage and a first AC current at or below a first AC current rating of the first inverter power station 143, and the second inverter power station 145 may be configured to provide a second AC power output at the AC voltage and a second AC current at or below a second AC current rating of the second inverter power station 145. The first inverter power station 143 may include a power output receptacle 147 configured to provide the first AC power output, and the second inverter power station 145 may include a power output receptacle 149 configured to provide the second AC power output.

The cutouts 131 on the bottom surface 129 of the housing 101 of the linking module 210 are positioned on the carrying handles 34 of the second inverter power station 145 to secure the linking module 210 in a stacked configuration with the second inverter power station 145. That is, the arc-shaped cutouts 131 sit securely on the oval-shaped carrying handles 34 of the second inverter power station 145. The feet 32 of the first inverter power station 143 are positioned in the power station mounts 133 on the upper surface 135 of the linking module to secure the first inverter power station 143 to the linking module 210. That is, the power station mounts 133 of the linking module 210 receive and secure the plurality of feet 32 of the first inverter power station 143 stacked on the upper surface 135 of the linking module 210. Accordingly, the linking module 210 is stacked between first and second inverter power stations 143, 145, with the linking module 210 secured on the oval-shaped carrying handles 34 and the second inverter power station 145 secured on power station mounts 133 of the linking module 210. Again, although the power station mounts 133 and cutouts 131 of the linking module 210 and feet 32 of the first and second inverter power stations 143, 145 are shown and described with particular shapes or configurations, in various embodiments, other shapes or configurations may be used.

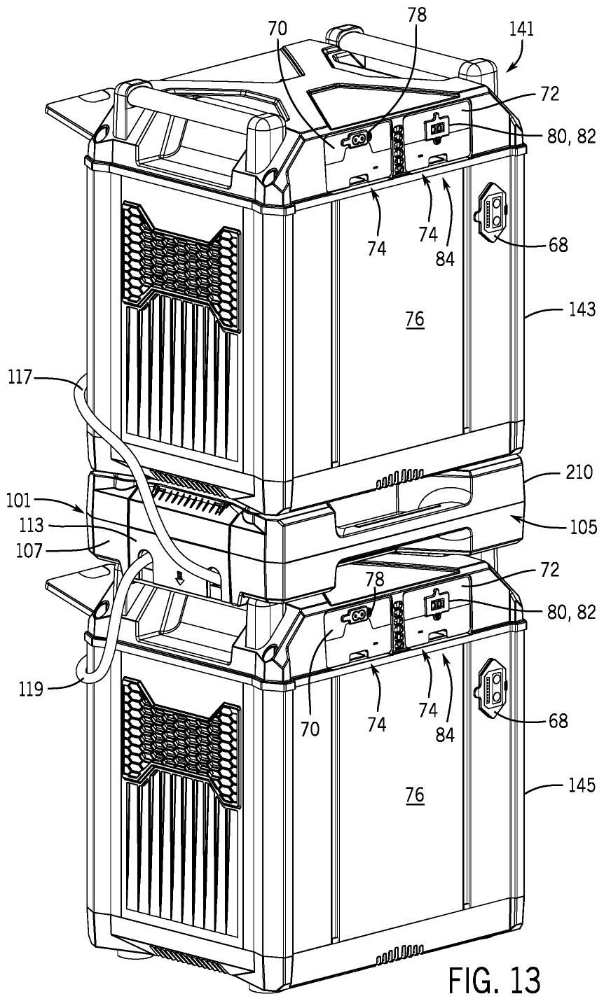

In various embodiments of the invention, the linking module 210 may be a parallel link capable of providing an AC power output that combines the AC power outputs from the two inverter power stations 143, 145 in parallel. In other embodiments of the invention, the linking module 210 may be a series link capable of providing an AC power output that combines the AC power outputs from the two inverter power stations 143, 145 in series. The power output receptacles 147, 149 of the first and second inverter power stations 143, 145 may include respective pairs of linking module connection ports 90 each coupled to one of the first and second pairs of connection cables 117, 119 of the linking module 210 extending through the slots 121 in the hinged door 113 in the right side 107 of the linking module 210, as shown in FIGS. 12 and 13. In other embodiments of the invention, the power output receptacles 147, 149 of the first and second inverter power stations 143, 145 may include AC power output receptacles 54 which may be configured to power the linking module 210 or an external electrical device (not shown in FIGS. 12-14). In various embodiments, the linking module 210 couples to the DC power output receptacles 52 of the first and second inverter power stations 143, 145 to receive power therefrom.

In various embodiments, the linking module 210 connects the first and second inverter power stations 143, 145 in parallel and therefore the linking module connection ports 90 may be respective pairs of parallel AC power output receptacles 151, 153. That is, the first inverter power station 143 may include a first pair of parallel AC power output receptacles 151, and the second inverter power station 145 may include a second pair of parallel AC power output receptacles 153. Each pair of parallel cables 117, 119 are electrically connectable to the first and second pairs of parallel AC power output receptacles 151, 153 and configured to electrically connect to one of the first and second pairs of parallel AC power output receptacles 151, 153 at a time to receive the first AC power output or the second AC power output. In FIGS. 12-13, the first pair of parallel AC power output receptacles 151 of the first power inverter station 143 is coupled to the first pair of connection cables 117 of the linking module 210, and the second pair of parallel AC power output receptacles 153 of the second inverter power station 145 is coupled to the second pair of connection cables 119.

The linking module 210 may be configured to electrically connect to the first inverter power station 143 to receive the first AC power output therefrom, electrically connect to the second inverter power station 145 to receive the second AC power output therefrom, and combine the first and second AC power outputs into a third AC power output at the AC voltage and a third AC current that is a combination of the first and second AC current. The linking module 210 may also be configured to provide the third AC power output to an electrical load (not shown in FIGS. 12-14) at the AC voltage and the third AC current at or below a third AC current rating that is a combination of the first and second AC current ratings. In various embodiments, the third AC current rating may be equal to a sum of the first and second AC current ratings.

In various embodiments, the one or more power output receptacles 159, 161 of the linking module 210 are configured to provide the third AC power output, and the third AC current rating may be an AC current rating of the power output receptacles 159, 161. For example, the linking module 210 may include at least one AC power output receptacle 159, 161 configured to provide a third AC power output at the AC voltage and a third AC current that is a combination of the first and second AC currents of the first and second inverter power stations 143, 145 and that does not exceed a third AC current rating of the linking module 210, the third AC current rating being higher than each of the first and second AC current ratings. The at least one AC power output receptacle 159, 161 of the linking module 210 may have a voltage rating equal to a voltage rating of the power output receptacles 147, 149 of the first and second inverter power stations 143, 145. In various embodiments, the one or more power output receptacles 159, 161 of the linking module 210 includes a 120V AC, 30 A RV receptacle (or a NEMA TT-30R receptacle) 163 and a 120V AC, 30 A locking receptacle (or a NEMA L5-30R receptacle) 165.

In various embodiments, the first inverter power station 143 includes a ground terminal 167, and the second inverter power station 145 includes a ground terminal 169. The linking module 210 may also include a first ground wire 171 electrically connectable to the ground terminals 167, 169 and configured to electrically connect to one of the ground terminals 167, 169 at a time. The linking module 210 may further include a second ground wire 173 electrically connectable to the first and second ground terminals 167, 169 and configured to electrically connect to one of the first and second ground terminals 167, 169 at a time. In FIG. 5, the first ground wire 171 of the linking module 210 is coupled to the ground terminal 167 of the first inverter power station 143, and second ground wire 173 of the linking module 210 is coupled to the ground terminal 169 of the second inverter power station 145.

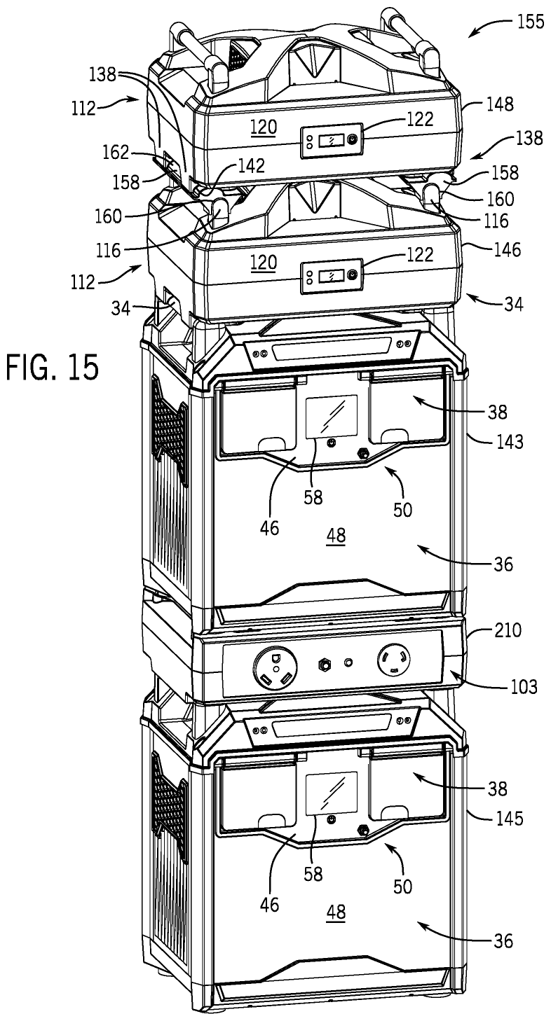

Referring now to FIG. 15, an upper-left front perspective view of a power station assembly 155 is shown with the first and second inverter power stations 143, 145 and linking module 210 of the power station assembly 154 of FIG. 12 and the expansion batteries 146, 148 of FIG. 6 in a stacked configuration, according to an embodiment of the invention. FIG. 15 shows the power station assembly 155 with two expansion batteries 146, 148 stacked on the first inverter power station 143, the first inverter power station 143 stacked on the linking module 210, and the linking module 210 stacked on the second inverter power station 145. In essence, the power station assembly 155 illustrates a combination of the power station assembly 154 of FIG. 7 and the power station assembly 141 of FIG. 12. In other words, power station assembly 155 shows how the power station 20 of FIG. 1 (as first power station 143) is connectable to more than one of the expansion battery 108 of FIG. 4 (as expansion batteries 146, 148) and to another power station 20 (as second power station 145) via the linking module 210 to expand the energy capacity and power output available to a load. Thus, the power station 20 may be called an expandable power station.

While the power station assembly 155 of FIG. 15 shows a particular configuration of the expansion batteries 146, 148, the first and second inverter power stations 143, 145, and linking module 210, the configuration shown should not be considered limiting. That is, the power station assembly 155 could include additional expansion batteries (not shown in FIG. 15) coupled to either the first or second inverter power stations 143, 145. In addition, although the stacked configuration shown consolidates the area used by the power station assembly 155, the components of the power station assembly 155 do not need to be in the stacked configuration to operate as designed. Rather, as long as the proper electrical connections and procedures are made and followed, each component of the power station assembly 155 will operate with its full functionality, as described above.

The stacked configuration is enabled by the engagement between the cutouts 131 in the feet 127 of the linking module 210 and the carrying handles 34 of the second inverter power station 145, the engagement between the power stations mounts 133 of the linking module 210 and the feet 32 of the first inverter power station 143, the engagement between cutouts 142 of the feet 138 of the first expansion battery 146 and the carrying handles 34 of the second inverter power station 145, the engagement between the cutouts 160 of the stacking adaptors 158 and the carrying handles 116 of the first expansion battery 146, and the engagement between the cutouts 142 of the feet 138 of the second expansion battery 148 and the upper surfaces 162 of the stacking adaptors 158. Additional expansion batteries 108 may be added to the stacked configuration via additional stacking adaptors 158. Further, a user may stack the power station assembly 155 in a variety of different manners. As a non-limiting example, a user may stack the first power station 143 with expansion batteries 146, 148, stack the second power station 145 with additional expansion batteries 108 (not shown in FIG. 15), and place the linking module 210 positioned between the two stacks or under the second power station 145. As another non-limiting example, the linking module 210 may include carrying handles (not shown) for receiving additional expansion batteries 108 such that the linking module 210 could be stacked between the first power station 143 and the additional expansion batteries 108 in the prior example. As yet another example, stack adaptors 158 and/or power station mounts 133 could be configured to engage with each other so as to enable the linking module 210 to receive additional expansion batteries 108 securely thereon. In other words, a user's ability to stack the components of the power station assembly 155 is not limited to what is shown and, instead, is variable based on the user's preference or space available.

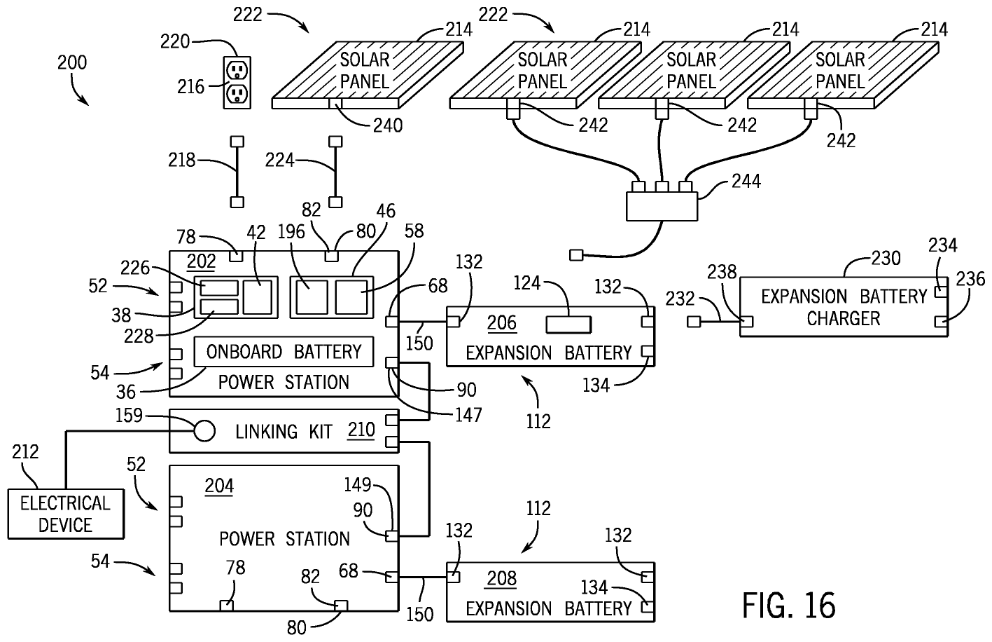

Referring now to FIG. 16, a block diagram of a power station assembly 200 is shown, according to an embodiment of the invention. The power station assembly 200 is shown with a first power station 202 coupled to a second power station 204 by the linking module 210 of FIG. 9, with the linking module 210 increasing the power output available to an electrical device 212 powered by the power station assembly 200. The first and second power stations 202, 204 are arranged similarly to the power station 20 of FIG. 1 and the first and second power stations 143, 145 of FIG. 12, and hence, like elements therein are numbered identically to corresponding elements in the power station 20 of FIG. 1 and the first and second power stations 143, 145 of FIG. 12. A first expansion battery 206 is coupled to the first power station 202, and a second expansion battery 208 is coupled to the second power station 204. The first expansion battery 206 and the second expansion battery 208 increase the energy capacity or runtime of the power station assembly 200. The expansion batteries 206, 208 are arranged similarly to the expansion battery 108 of FIG. 4 and the expansion batteries 146, 148 of FIG. 6, and thus, like elements therein are numbered identically to corresponding elements in the expansion battery 108 of FIG. 4 and the expansion batteries 146, 148 of FIG. 6.

The power stations 202, 204 may each include one or more linking module connection ports 90 configured to receive connections to the linking module 210. The linking module 210 may be used as a parallel link to couple together the AC power outputs from the linking module connection ports 90 of the two power stations 202, 204 to increase output current or a series link to couple together the AC power outputs from the linking module connection ports 90 of the two power stations 202, 204 to increase output voltage. The power stations 202, 204 are also shown with an external battery port 68 configured to connect expansion batteries 206, 208, a DC power inlet receptacle 80 configured to connect to a DC power source 222 and an AC power inlet receptacle 78 configured to connect to an AC power source 216. The power stations 202, 204 may also include DC power output receptacles 52 and AC power output receptacles 54 configured to power electrical devices coupled to the power station 202, 204.

The AC power inlet receptacle 78 couples to the AC power source 216 using an AC cord 218. The AC power source 216 may be a traditional wall outlet 220 coupled to the utility grid. The AC power inlet receptacle 78 may support AC fast charging (for example, at 120V AC, 50 Hz/60 Hz, 4.5 A MAX). The DC power inlet receptacle 80 may include an APP input port 82 configured to couple to the DC power source 222 using an APP cord 224. The DC power source 222 may include one or more solar panels 214. The APP input port 82 may support DC fast charging (for example, at 10V-28V DC, 25 A MAX).

The power stations 202, 204 may also include a control system 38 including an inverter 42, a processor 226 and memory 228. While the inverter 42 is illustrated as part of the control system 38, the inverter 42 may be controlled by the control system 38 as a separate element therefrom. The processor 226 may be one or more computer processors or microprocessors capable of executing a computer program having instructions including executable code. The executable code may be stored on the memory 228 which may include any suitable non-transitory media that can store executable code for use by the processor 226 to perform the presently disclosed techniques. The memory 228 may be any suitable type of computer-readable media that can store the executable code, data, analysis of the data, or the like. The power stations 202, 204 may also include a control panel 46 having an automatic display 58 and a battery gauge 196.

The linking module 210 may be configured to electrically connect to the first power station 202 to receive a first AC power output at an AC voltage and a first AC current less than or equal to a first AC current rating and electrically connect to the second power station 204 to receive a second AC power output at the AC voltage and a second AC current less than or equal to a second AC current rating. The linking module 210 may also be configured to electrically connect the first and second AC power outputs in parallel to combine the first and second AC power outputs into a third AC power output at the AC voltage and a third AC current that is a combination of the first and second AC currents, and provide the third AC power output to an electrical device or load 212.

In various embodiments of the invention, each of the two connectable inverter power stations 202, 204 include at least one respective power output receptacle 147, 149 configured to provide a respective first and second rated AC power output. More specifically, the linking module 210 may be configured to electrically connect to the first power station 202 via a first AC power output receptacle 147 of the first power station 202, with the first AC current rating being an AC current rating of the first AC power output receptacle 147. The linking module 210 may be configured to electrically connect to the second power station 204 via a second AC power output receptable 149 of the second power station 204, with the second AC current rating being an AC current rating of the second AC power output receptacle 149. In various embodiments, first and second AC power output receptacles 147, 149 have an AC voltage of approximately 120V (within plus or minus 10V, or from 110V to 130V), and the first and second AC current ratings are approximately 15 A (within plus or minus 3 A, or from 12 A to 18 A).

In various embodiments of the invention, the power station assembly 200 may include two connectable inverter power stations 202, 204 each configured to provide a first rated AC power output at a first voltage rating and a first current rating. When the linking module 210 electrically connects the two connectable power stations 202, 204, the power station assembly 200 may include a second rated AC power output at the first voltage rating and a second current rating higher than the first current rating. According to various embodiments, when the linking module 210 electrically connects the two connectable power stations 202, 204, the linking module 210 is capable of providing the second rated AC power output. The linking module 210 may include at least one power output receptacle 159 configured to provide the second rated AC power output. Accordingly, the linking module 210 may include a second rated AC power output at the first voltage rating and a second current rating higher than the first current rating. The linking module 210 may be a parallel link configured to couple the two connectable inverter power stations 202, 204 in parallel and capable of providing a rated AC power output that combines the rated AC power outputs from the two connectable inverter power stations 202, 204.

An expansion battery charger or charging module 230 is configured to charge the expansion batteries 206, 208. The expansion battery charging module 230 may receive power from the AC power source 216 and/or the DC power source 222 and supply the power to one expansion battery 206, 208 using a power cord 232. The expansion battery charging module 230 includes an AC input port 234, an APP input port 236, and a power DC output port 238. The AC input port 234 is configured to couple to an AC power source such as, for example, the AC power source 216 using the AC cord 218. The APP input port 236 is configured to couple to a DC power source such as, for example, the DC power source 222 using the APP cord 224.

The expansion batteries 206, 208 may include a charging module input port 134 that connects to the power output port 238 of the expansion battery charging module 230 using the power cord 232. The expansion batteries 206, 208 may also include a pair of battery connection ports 132 that couple to a battery connection port 132 of another expansion battery 206, 208 or to the external battery port 68 of a power station 202, 204. A connection cable 150 may electrically couple the expansion batteries 206, 208 to the power stations 202, 204 when coupled to one battery connection port 132 and one external battery port 68. The expansion batteries 206, 208 may each be connected to one or more additional expansion batteries (not shown in FIG. 16) to increase the battery capacity available to the power stations 202, 204.

In various embodiments, the solar panels 214 of the DC power source 222 may be rated between 10V-28V with MC4 or APP connectors and may power one or more of the power stations 202, 204 or the expansion batteries 206, 208 via the expansion battery charging module 230. The solar panels 214 may include APP connectors 240 that can be coupled directly to the APP input ports 82 of the power stations 202, 204 or the APP input port 236 of the expansion battery charging module 230. The solar panels 214 may alternatively include MC4 connectors 242 that can be connected to the APP input ports 82, 236 using an MC4 to APP solar charge harness 244. The solar charge harness 244 may have an APP plug connectable to the power stations 202, 204 and the expansion battery charging module 230 with MC4 connections such as, for example, three MC4 connections to couple up to three or more solar panels 214 having MC4 connectors 242.

In some embodiments of the invention, the capacity of the onboard battery system 36 and/or each expansion battery 206, 208 could have an approximate (within plus or minus 5%) capacity of 1600 Wh or 3200 Wh. The onboard battery system 36 and/or each battery system 112 of the expansion batteries 206, 208 may have a rated output voltage of approximately 46.8V and a max output voltage of approximately 54.6V-55V, although the battery systems 36, 112 could have any suitable voltage rating such as 12V, 24V, or 48V, as non-limiting examples. The percent battery level of the battery systems 36, 112 may correspond to the battery voltage. As a non-limiting example, 100% battery level could correspond to 55V, and 0% battery level could correspond to 38V. In some embodiments, when power stations 202, 204 operate at full load, they will not reach 5% THD until the voltage drops to 42.57V with 17% battery capacity, and when power stations 202, 204 operate at full load with double the battery capacity, they will not reach 5% THD until the voltage drops to 42.70V with 11% battery capacity. In various embodiments, the power stations 202, 204 may each provide single phase AC power at 60 Hz with a current rating of approximately 13.3 A at 120V.

One skilled in the art will appreciate that embodiments of the invention may be interfaced to and controlled by a computer readable storage medium having stored thereon a computer program. The computer readable storage medium includes a plurality of components such as one or more of electronic components, hardware components, and/or computer software components. These components may include one or more computer readable storage media that generally stores instructions such as software, firmware and/or assembly language for performing one or more portions of one or more implementations or embodiments of a sequence. These computer readable storage media are generally non-transitory and/or tangible. Examples of such a computer readable storage medium include a recordable data storage medium of a computer and/or storage device. The computer readable storage media may employ, for example, one or more of a magnetic, electrical, optical, biological, and/or atomic data storage medium. Further, such media may take the form of, for example, floppy disks, magnetic tapes, CD-ROMs, DVD-ROMs, hard disk drives, and/or electronic memory. Other forms of non-transitory and/or tangible computer readable storage media not listed may be employed with embodiments of the invention.

A number of such components can be combined or divided in an implementation of a system. Further, such components may include a set and/or series of computer instructions written in or implemented with any of a number of programming languages, as will be appreciated by those skilled in the art. In addition, other forms of computer readable media such as a carrier wave may be employed to embody a computer data signal representing a sequence of instructions that when executed by one or more computers causes the one or more computers to perform one or more portions of one or more implementations or embodiments of a sequence.

Beneficially, embodiments of the invention provide a power station assembly including a linking module configured to receive first and second power outputs from first and second power stations, respectively, and combine the first and second power outputs into an increased power output. The linking module is further configured to fit together with the first and second power stations in a stacked configuration, with the linking module positioned between the first and second power stations. In the stacked configuration, a front end of the linking module including at least one power output receptacle and front sidewalls of the first and second power stations including at least one power output receptacle are facing the same direction. First and second pairs of connection cables extend out from an interior cavity of the linking module though a door to electrically connect to the first and second power stations, respectively, in order to receive the first and second power outputs therefrom. The arrangement of the stacked configuration provides convenience and efficiency to a user of the power assembly by allowing the user to view the front sides of the first and second power stations and the linking module at the same time.

Therefore, according to one embodiment of the invention, a power station assembly includes first and second power stations and a linking module configured to receive first and second power outputs from the first and second power stations, respectively, and combine the first and second power outputs into an increased power output. Each of the first and second power stations includes a housing having opposing first and second sidewalls, an onboard battery positioned within the housing, and a plurality of power output receptacles positioned on the first sidewall and powered by the onboard battery system. The linking module includes a housing having opposing first and second ends. The housing is configured to fit together with the housings of the first and second power stations in a stacked configuration, with the housing of the linking module between the housings of the first and second power stations and with the first end and the first sidewalls of the housings of the first and second power stations facing the same direction. The linking module also includes at least one power output receptacle located at the first end of the housing and configured to provide the increased power output.

According to another embodiment of the invention, a power station assembly includes first and second power stations and a linking module configured to receive first and second power outputs from the first and second power stations and combine the first and second power outputs into an increased power output. Each of the first and second power stations includes a housing having opposing first and second sidewalls, an onboard battery system positioned within the housing, and a plurality of power output receptacles positioned on the first sidewall and powered by the onboard battery system. The linking module includes a housing having opposing first and second ends, a bottom surface configured to securely stack on top of the housing of one of the first and second power stations at a time such that the first end and the first sidewall of the housing of the first and second power stations on which the bottom surface of the housing of the linking module is stacked are facing the same direction, and a top surface configured to securely receive stacked thereon the housing of one of the first and second power stations at a time such that the first end and the first sidewall of the housing of the first power station stacked on the top surface of the housing of the linking module are facing the same direction. The linking module further includes at least one power output receptacle located at the first end of the housing of the linking module and configured to provide the increased power output.

According to yet another embodiment of the invention, a method of stacking a power station assembly includes positioning a first power station on a surface. The first power station includes a housing comprising opposing first and second sidewalls, an onboard battery system positioned within the housing, and a plurality of power output receptacles positioned on the first sidewall and powered by the onboard battery system. The method further comprises stacking a linking module on top of the housing of the first power station. The linking module is configured to receive first and second power outputs from the first power station and a second power station, respectively, and combine the first and second power outputs into an increased power output. The linking module includes a housing having opposing first and second ends, a bottom surface securely stacked on top of the housing of the first power station such that the first end and the first sidewall of the housing of the first power station are facing the same direction, and a top surface configured to securely receive stacked thereon the second power station. The linking module also includes at least one power output receptacle located at the first end of the housing and configured to provide the increased power output. In addition, the method includes stacking the second power station on the top surface of the linking module. The second power station includes a housing having opposing first and second sidewalls and stacked on the top surface of the housing of the linking module such that the first sidewall and the first end of the housing of the linking module are facing the same direction. The second power station additionally includes an onboard battery system positioned within the housing and a plurality of power output receptacles positioned on the first sidewall and powered by the onboard battery system.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. The singular forms ‘a’, ‘an’, and ‘the’ in the claims include plural reference unless the context clearly dictates otherwise. Additionally, while various embodiments of the invention have been described, it is to be understood that aspects of the invention may include only some of the described embodiments. Accordingly, the invention is not to be seen as limited by the foregoing description but is only limited by the scope of the appended claims.

What is claimed is:

1. A power station assembly comprising:
first and second power stations, each of the first and second power stations comprising:
a housing comprising opposing first and second sidewalls;
an onboard battery positioned within the housing;
a plurality of power output receptacles positioned on the first sidewall and powered by the onboard battery system; and
a linking module configured to receive first and second power outputs from the first and second power stations, respectively, and combine the first and second power outputs into an increased power output, the linking module comprising:
a housing comprising opposing first and second ends, the housing configured to fit together with the housings of the first and second power stations in a stacked configuration, with the housing of the linking module between the housings of the first and second power stations and with the first end and the first sidewalls of the housings of the first and second power stations facing the same direction; and
at least one power output receptacle located at the first end of the housing and configured to provide the increased power output.

2. The power station assembly of claim 1 wherein housing of the linking module comprises:
a bottom surface configured to securely stack on top of the housing of one of the first and second power stations at a time; and
a top surface configured to securely receive stacked thereon the housing of one of the first and second power stations at a time.

3. The power station assembly of claim 2 wherein:
each housing of the first and second power stations comprises:
a plurality of supports extending from the housing to support the housing of the linking module; and
a plurality of feet on a bottom surface thereof;
the bottom surface of the housing of the linking module comprises a plurality of feet and a plurality of cutouts, each cutout of the plurality of cutouts extending through at least one foot of the plurality of feet and configured to securely sit on the plurality of supports of the housing of one of the first and second power stations at a time; and
the top surface of the housing of the linking module comprises a plurality of power station mounts configured to receive and secure the plurality of feet of one of the first and second power stations at a time.

4. The power station assembly of claim 1 wherein the linking module further comprises first and second pairs of connection cables configured to electrically connect to one of the first and second power stations at a time.

5. The power station assembly of claim 4 wherein each of the first and second power stations comprises a pair of linking module connection ports configured to electrically connect to one of the first and second pairs of connection cables of the linking module at a time.

6. The power station assembly of claim 4 wherein the housing of the linking module comprises an interior compartment configured to store the first and second pairs of connection cables therein.

7. The power station assembly of claim 6 wherein the housing of the linking module comprises a door positioned on a side thereof between the front and rear ends and allowing access to the interior compartment.

8. The power station assembly of claim 7 wherein the door comprises first and second slots configured to allow the first and second connection cables to extend out of the interior compartment and electrically connect to the first and second power stations.

9. A power station assembly comprising:
first and second power stations, each of the first and second power stations comprising:
a housing comprising opposing first and second sidewalls;
an onboard battery system positioned within the housing; and
a plurality of power output receptacles positioned on the first sidewall and powered by the onboard battery system; and
a linking module configured to receive first and second power outputs from the first and second power stations and combine the first and second power outputs into an increased power output, the linking module comprising:
a housing comprising:
opposing first and second ends;
a bottom surface configured to securely stack on top of the housing of one of the first and second power stations at a time such that the first end and the first sidewall of the housing of the first and second power stations on which the bottom surface of the housing of the linking module is stacked are facing the same direction; and
a top surface configured to securely receive stacked thereon the housing of one of the first and second power stations at a time such that the first end and the first sidewall of the housing of the first power station stacked on the top surface of the housing of the linking module are facing the same direction; and
at least one power output receptacle located at the first end of the housing of the linking module and configured to provide the increased power output.

10. The power station assembly of claim 1 wherein the linking module further comprises first and second pairs of connection cables configured to electrically connect to one of the first and second power stations at a time.

11. The power station assembly of claim 10 wherein each of the first and second power stations comprises a pair of linking module connection ports configured to electrically connect to one of the first and second pairs of connection cables of the linking module at a time.

12. The power station assembly of claim 10 wherein the housing of the linking module comprises an interior compartment configured to store the first and second pairs of connection cables therein.

13. The power station assembly of claim 12 wherein the housing of the linking module comprises a door positioned on a side thereof between the front and rear ends and allowing access to the interior compartment.

14. The power station assembly of claim 13 wherein the door comprises first and second slots configured to allow the first and second connection cables to extend out of the interior compartment and electrically connect to the first and second power stations.

15. The power station assembly of claim 9 wherein:
each housing of the first and second power stations comprises:
a plurality of supports extending from the housing to support the housing of the linking module; and
a plurality of feet on a bottom surface thereof;
the bottom surface of the housing of the linking module comprises a plurality of feet and a plurality of cutouts, each cutout of the plurality of cutouts extending through at least one foot of the plurality of feet and configured to securely sit on the plurality of supports of the housing of one of the first and second power stations at a time; and
the top surface of the housing of the linking module comprises a plurality of power station mounts configured to receive and secure the plurality of feet of one of the first and second power stations at a time.

16. A method of stacking a power station assembly, the method comprising:
positioning a first power station on a surface, the first power station comprising:
a housing comprising opposing first and second sidewalls;
an onboard battery system positioned within the housing; and
a plurality of power output receptacles positioned on the first sidewall and powered by the onboard battery system;
stacking a linking module on top of the housing of the first power station, the linking module configured to receive first and second power outputs from the first power station and a second power station, respectively, and combine the first and second power outputs into an increased power output, the linking module comprising:
a housing comprising:
opposing first and second ends;
a bottom surface securely stacked on top of the housing of the first power station such that the first end and the first sidewall of the housing of the first power station are facing the same direction; and
a top surface configured to securely receive stacked thereon the second power station; and
at least one power output receptacle located at the first end of the housing and configured to provide the increased power output; and
stacking the second power station on the top surface of the linking module, the second power station comprising:
a housing comprising opposing first and second sidewalls, the housing stacked on the top surface of the housing of the linking module such that the first sidewall and the first end of the housing of the linking module are facing the same direction;
an onboard battery system positioned within the housing; and
a plurality of power output receptacles positioned on the first sidewall and powered by the onboard battery system.

17. The method of claim 16 further comprising:
electrically connecting a first pair of connection cables of the linking module to a pair of linking module connection ports on the first sidewall of the housing of the first power station; and
electrically connecting a second pair of connection cables of the linking module to a pair of linking module connection ports on the first sidewall of the housing of the second power station.

18. The method of claim 17 further comprising opening a door in a side of the housing of the linking module to retrieve the first and second pairs of connection cables from an interior compartment of the housing of the linking module.

19. The method of claim 18 further comprising closing the door in the side of the housing of the linking module such that the first pair of connection cables extends out of the interior compartment through a first slot in the door and the second pair of connection cables extends out of the interior compartment through a second slot in the door.

20. The method of claim 16 further comprising:
stacking an expansion battery comprising a battery system on top of the housing of the second power station; and
electrically connecting the battery system of the expansion battery to the onboard battery of the second power station to provide an increased battery level available to the second power station.
